(19) United States
(12) Patent Application Publication
(10) Pub. No.: US 2002/0112035 A1
(43) Pub. Date: Aug. 15, 2002

(54) System and method for performing content experience management

(76) Inventors: Brian M. Carey, Hoboken, NJ (US); Francois Chambard, Pawtucket, RI (US); Scott S. Elias, New York, NY (US); Daron M. Horwitz, New York, NY (US); Andrew J. Stein, New York, NY (US)

Correspondence Address: SHAW PITTMAN LLP, 1650 Tysons Boulevard, McLean, VA, 22102, US

(21) Appl. No.: 09/984,428

(22) Filed: Oct. 30, 2001

Related U.S. Application Data
(60) Provisional application No. 60/243,862, filed on Oct. 30, 2000.

(51) Int. Cl. G06F 15/16

(52) U.S. Cl. 709/219

(57) ABSTRACT

A system and method for content experience management is disclosed. The system includes content, user and client databases, and a recommendation engine and server that facilitates the delivery, presentation, and management of several types of content (e.g., visual, audio, etc.) by businesses to design meaningful, lasting and effective experiences for consumers. The method and computer program product keeps consumers utilizing a new media device (e.g., a PC, WAP device, PDAs, or mobile phone) engaged, communicates brand messages, and develops consumer loyalty via a variety of touchpoints (e.g., the Internet). The business would employ the system described herein to return appropriate experience enhancing content to the consumer. The experience enhancing content is selected by the recommendation engine based on user profile information, the business' brand data and content rules stored in their respective databases. The content is then presented to the consumer as part of the Web browsing experience. The consumer's reactions (e.g., length of stay, purchases, and locations of clicks) are correlated to the content delivered and sent to the business as “feedback data.” Because the system is outcome-focused, the feedback data are forwarded to the system. This allows the recommendation engine to refine its future content selection process (i.e., so the recommendation engine can “learn” what content works for what consumers) by updating the rules in the system's several databases.

This application claims the benefit of U.S. Provisional Application No. 60/243,862, filed Oct. 30, 2000, which is hereby incorporated by reference herein in its entirety.

### BACKGROUND OF THE INVENTION

1. Field of the Invention

The present invention relates generally to content management systems, and more particularly to computer-based systems that store, select, deliver, present and manage content information for both traditional and non-traditional media.

2. Background of the Invention

In today's technological climate, the availability of low-cost personal computers, networking equipment and related technology has dramatically changed the way people communicate. For example, the explosion of people connected to the global (sometimes referred to as the “public”) Internet has dramatically increased the usage of electronic mail (e-mail) for communications, and the use of browsers to navigate between and view (i.e., browse) documents through the World-Wide Web (WWW), and other Internet-related services. This climate has not only affected personal communications between people, but also communications between consumers and businesses—this has come to be known as “e-commerce.”

Further, the technological explosion in the field of wireless telecommunications has brought about numerous new devices that allow people to receive information and communicate with one another. Such devices include mobile phones, wireless application protocol (WAP) devices, personal data assistants (PDAs), interactive television, set-top box enabled devices and the like. These devices, capable of utilizing several communications mediums, as well as linking to the Internet, further harvest the ubiquitous global connectivity achieved by the Internet.

It is well known that businesses have utilized traditional media—film, television and radio—to harness the power of the combination of visual effects, words, music and/or sound to shape emotions and behaviors in order to create indelible memories. These memories create brand recognition and translate into sales.

Yet, while the Internet has significantly fulfilled its promise in terms of achieving global connectivity of people, its full potential has not quite been realized in terms of content delivery.

This is especially true in the area of e-commerce. In other words, despite the capability of the Internet to deliver numerous types (formats) of data, it is currently a global ocean of silent content. That is, audio content (e.g., music, sound effects, voice narrative, jingles, timely silence, etc.) is conspicuously absent from the Internet-based applications (e.g., WWw sites) where consumers and businesses interact.

The Internet, along with personal computers, mobile phones, wireless application protocol (WAP) devices, personal data assistants (PDAs) and the like (collectively referred to as “new media”), owned by today's consumers, each represent an opportunity where business can expose their brands to consumers. These new media are not fully exploited, especially within e-commerce activities, to shape resonant consumer experience by providing rich content and help businesses implement their branding strategies. New media applications, through the Internet and wireless devices, offer a unique advantage that has been lacking in traditional media—the ability to interact with a target audience.

Therefore, given the foregoing, a need exists for a system and a method for content experience management. Among other things, the system and method, for example, a computer program product, should allow businesses to use the emotional power of content (e.g., audio) to design meaningful, interactive, lasting and effective experiences for consumers that, preferably, will translate into value for both consumers and businesses alike.

### SUMMARY OF THE INVENTION

The present invention relates to a system and a method, for example, a computer program product, for content experience management. Embodiments of the system and method disclosed herein allow businesses to use the emotional power of several types of content to design meaningful, lasting and effective experiences for consumers. Thus, in an embodiment, the present invention facilitates the selection, storage, delivery, presentation, and management of the right audio content (e.g., music, sound effects, voice narrative, jingles, timely silence, etc.) to build emotional bonds between companies and consumers. The selection, storage, delivery, presentation, and management of the right content is aimed at keeping consumers engaged, communicating brand messages, and developing consumer loyalty. The selection, storage, delivery, presentation, and management of the right content is also aimed at causing or influencing specific, targeted behaviors, and avoiding targeted behaviors (e.g., abandoning an e-commerce transaction).

Beyond the Internet and wireless, there has been an explosion of places where brands and consumers interact. These locations are called “touchpoints.” Each of these touchpoints represents a strategic crossroads where the power of music and sound are harnessed to shape emotions and behaviors in order to create indelible memories.

Embodiments of the present invention include an application service provider model and a stand-alone application program that allows a business, for example, to add rich audio content (i.e., “sonify”) touchpoints where they interact with their customers. In an alternate embodiment, the touchpoints can provide some or all of the functionality of the components of the system of the present invention as described herein.

Advantages of embodiments of the present invention include allowing businesses the ability to manage content (e.g., audio), track consumer response, and respond accordingly as part of the brand strategies.

Other advantages of embodiments of the present invention include providing the ability to deliver and measure tangible consumer outcomes and behaviors (sales, page views, click-throughs, return visits, etc.) associated with the content (e.g., music and sound delivered).

Still other advantages of embodiments of the present invention is that it can be a part of an integrated system and business strategy that combines advisory (e.g., consulting services), content (e.g., creation of music, sound effects, narration, and other sounds), technology, and research & analysis of products and services.

Yet another advantage of an embodiment of the present invention is that it allows both strategic (e.g., branding tool, deployment across multiple touchpoints, brand architecture) and tactical (e.g., experience design, physical navigation, spatial orientation, memory, entertainment, education, attention, influence behavior/action, etc.) uses of content (e.g., audio) to be utilized in managing resonant consumer experiences.

Many e-businesses collect information about prospects' and customers' interests and tendencies. Thus, additional advantages of embodiments of the present invention include allowing for business, entities, etc., to use this intelligence to be used to craft meaningful, personalized experiences that engage visitors and encourage return visits through tailored, customized touchpoint interactions.

Yet another advantage of embodiments of the present invention is that they are outcome-focused and utilize an iterative loop process that constantly improves over time (i.e., if the selected content does not send the right message or elicit the intended consumer behavior or emotion, then the selection rules are improved to achieve the intended outcome).

Further features and advantages of the invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1A is a block diagram illustrating the system architecture of an embodiment of the present invention, showing connectivity among the various components;

FIG. 1B is a block diagram illustrating the system architecture of an alternative audio embodiment of the present invention, showing connectivity among the various components;

FIG. 2 is a block diagram illustrating the system architecture of an embodiment of the present invention, showing connectivity among the various components;

FIG. 3A is a flowchart depicting an embodiment of the operation and control flow of the content experience management system of the present invention;

FIG. 3B is a block diagram depicting information stored in a user profile database in an embodiment of the content experience management system of the present invention;

FIG. 4A is a flowchart depicting an embodiment of the operation and control flow of the rules application and feedback of the content experience management system of the present invention;

FIGS. 4B1-4B7 are flowcharts depicting an alternative embodiment of the operation and control flow of the rules application and feedback of the content experience management system of the present invention;

FIG. 5 is window or screen shot generated by the graphical user interface of the present invention in a remote content management embodiment of the present invention;

FIG. 6A is a window or screen shot generated by the graphical user interface of the present invention in a content enriched, Web site navigation embodiment of the present invention;

FIG. 6B is a window or screen shot generated by the graphical user interface of the present invention in a content enriched, interactive build embodiment of the present invention;

FIG. 6C is a window or screen shot generated by the graphical user interface of the present invention in a content enriched, commerce embodiment of the present invention; and

FIG. 7 is a block diagram illustrating the determination of an entity's optimal contact pathway according to an embodiment of the present invention.

### DETAILED DESCRIPTION OF THE PREFERRED EMBODIMENTS

Examples of Application Service Provider Model

In one embodiment of the present invention, an application service provider (ASP) provides and allows access, perhaps on a subscription or per-use basis, to a new media content experience management tool via the global Internet or other new media. That is, the application service provider would provide the hardware (e.g., servers) and software (e.g., database) infrastructure, application software, content files, customer support, and billing mechanism to allow its clients (e.g., e-businesses, companies, trade organizations, business concerns and the like) to facilitate the selection, storage, delivery, presentation, and management of content (i.e., audio content such as music, sound effects, voice narrative, jingles, timely silence, etc.). Preferably, this builds emotional bonds between companies and consumers.

The selection, delivery and presentation of the selected content allows the power of the audio content to shape emotions and behaviors, and create indelible memories. That is, the selection, storage, delivery, presentation, and management of the right content is aimed at keeping consumers engaged, communicating brand messages, and developing consumer loyalty, causing or influencing specific, targeted behaviors, and avoiding targeted behaviors (e.g., abandoning an e-commerce transaction). Selected content can also be used to inform, support, guide, or promote learning, sharing, or security.

“New media,” as used herein, is media that is not traditional media (i.e., film, traditional, non-interactive television, or radio). That is, new media refers to such mediums as the Internet, Intranets, Extranets, wireless networks, mobile devices, gaming consoles, kiosks, interactive television, other interactive devices, etc., which convey meaningful information and/or content to a user, but has either previously lacked audio content or contained inappropriate content for the brand or the consumer (e.g., provided sound, but not the right sound at the right time for the specific user).

As mentioned above, despite its capability to deliver numerous types (formats) of data, the Internet is currently, largely a global ocean of silent content. Thus, in an embodiment, the content experience management system of the present invention allows the sonification of the Internet. “Sonification,” “sonified,” and “sonifying,” as used herein, refers to the process of designing a sound interface and adding audio content (e.g., sound design, music, sound effects, voice narrative, jingles, timely silence, etc.) to new media touchpoints.

Beyond the Internet and wireless, there has been an explosion of places where brands and consumers interact. These locations are called “touchpoints.” Each of these touchpoints represents a strategic crossroads where the power of music and sound are harnessed to shape emotions and behaviors in order to, preferably, create indelible memories. That is, “touchpoint,” as used herein, is any medium that is capable of providing a resonant experience to an individual user (i.e., consumer), of which new media are just one category of touchpoints. In other words, a touchpoint is a point/interface where a consumer interacts with a company or brand. Categories and specific examples of touchpoints are shown in TABLE 1.1. Thus, after reading the following description, it will be apparent to one skilled in the relevant art(s) how to implement the following invention in alternative embodiments to facilitate the selection, storage, delivery, presentation, and management of the right content to build emotional bonds between companies and consumers using each exemplary touchpoint listed in the TABLE 1.1 (e.g., interactive television, sponsored programming spots, radio, television, call centers, kiosks, audio magazines, interactive games (group and solo), wireless devices, embedded sounds, music on hold, physical plant, corporate communications, location based entertainment, retail, Web specific content, global communications, training, restaurants, trade sale events, Web over phone, environments, audio navigation systems, personal digital assistants (PDAs), consumer products, commercials/advertisements, affinity programs, promotional materials, and consumer products).

TABLE 1.1
TOUCHPOINTS

| | |
|---|---|
| Consumer products | Environments |
| Cars and motorcycles | Retail |
| Toys | Office spaces |
| Watches | Restaurants |
| Appliances | Trade shows |
| Internet/Broadband | Museums |
| Web pages | Sports and Entertainment |
| Online Databases | Location-based Entertainment: |
| TVs | casinos, theme parks |
| Wireless | Sport arenas and events |
| Cell phones | “Experience museums” |
| Personal Digital Assistants | Promotion |
| GPSs | Promotional CDs |
| Pagers | E-mail |
| Information Appliances | Mass-mailing items |
| Computers | Event cards |
| Digital Cameras | Coupons |
| Interactive Television | Travel |
| Navigation Systems | Airplanes |
| Building signage | Trains and train stations |
| Interactive kiosks | Airports |
| Subway/trains in-board messaging | Software |
| Assistive technologies for persons with | Applications, Suites, Games |
| disabilities. | |

It is known in the relevant art(s), that companies collect information about prospects' and customers' interests and tendencies. Thus, the experience content management tool of the present invention would be used by subscribers to allow this intelligence to be utilized to craft meaningful, personalized Web (and other new media and traditional media) experiences that engage visitors and encourage return visits through tailored, customized interactions. These personalized experiences, each designed (i.e., sonified) for a particular touchpoint, will enhance customer loyalty, satisfaction, and retention, ultimately resulting in higher conversion rates (e.g., ratio of browsers to buyers) and greater profitability for businesses.

As suggested above, in an embodiment of the present invention, an ASP may provide businesses with access to the content experience management tool of the present invention and charge on a subscriber or per-use basis. In an alternate embodiment, however, the ASP may provide businesses with access to the content experience management tool of the present invention on an outcome basis. That is, the content experience provided by the system of the present invention would be monitored in order to calculate a quantitative measurement (i.e., a rating) of the effectiveness of the selected content and the qualitative experience based on targeted outcomes which can include behaviors as described herein. Effectiveness would be judged on pre-defined objective outcomes such as sales, consumer visits, session time, depth of site viewed, areas visited, information shared, or links forwarded. Thus, the higher the ratings achieved, the more the business would be required to pay to the ASP.

Example Content Delivery Embodiments

In an alternate embodiment of the present invention, a stand-alone application program is provided to clients, which serves as the content experience management system. The application program would provide similar functionality as described herein with reference to the application service provider model mentioned above. Such software would allow companies to perform their own sonification and content (e.g., audio) management without necessarily having a subscription to an ASP facility providing the management services described herein.

In an alternate embodiment of the present invention, the application program, instead of being accessed via the global Internet, would run locally on proprietary equipment and be networked among the local or wide area network (e.g., over an Ethernet, intranet, or extranet) of an entity allowing multiple users to access and use the content experience management system.

In an alternate embodiment of the present invention, a touchpoint, such as a device or kiosk, can provide some or all of the functionality of the components of the content experience management tool of the present invention as described herein.

Such touchpoints, as will be apparent to one skilled in the relevant art after reading the description herein, would further allow for stand-alone implementations of the present invention.

In an alternate embodiment of the present invention, touchpoints can provide some or all of the functionality of the components of the content experience management tool as described herein. Furthermore, such touchpoints can maintain connectivity with a centrally managed (or an independently or discretely managed) content experience management tool or alternatively the touchpoints would share collected consumer intelligence data, as described herein, among multiple touchpoints (i.e., a touchpoint “peer-to-peer” model).

According to embodiments of the present invention, the above-described new media content under-utilization problem as described herein is solved by providing a system and a method, including, for example, a computer program product to shape resonant consumer experiences and help businesses express their brand values and implement their branding strategies, while exploiting the ability to interact with consumers, corporations, and other audiences through such new media. The present invention allows a business (i.e., a business subscribing to the ASP) to architect the end user's experience by organizing, arranging, and sharing content that are valuable because they deliver a direct personal experience of a product's material, informational, and emotional or other personally relevant benefits.

The present invention is described in terms of the above examples. This is for convenience only and is not intended to limit the application of the present invention. In fact, after reading the following description, it will be apparent to one skilled in the relevant art(s) how to implement the following invention in alternative embodiments (e.g., the selection, storage, delivery, presentation, and management of content that is visual, aromatic, tactile, gustatory, spiritual, etc.).

The terms “client,” “subscriber,” “entity,” “company,” “business concern, and the plural form of these terms are used interchangeably throughout herein to refer to those who would access, use, and manage their content as part of their brand strategy, and thus profit from the content experience management system of the present invention.

The terms “user,” “end-user,” “consumer,” “customer,” and the plural form of these terms are used interchangeably throughout herein to refer to those who would benefit from the content experience management system of the present invention through resonant touchpoint experiences.

Example ASP System Architectures

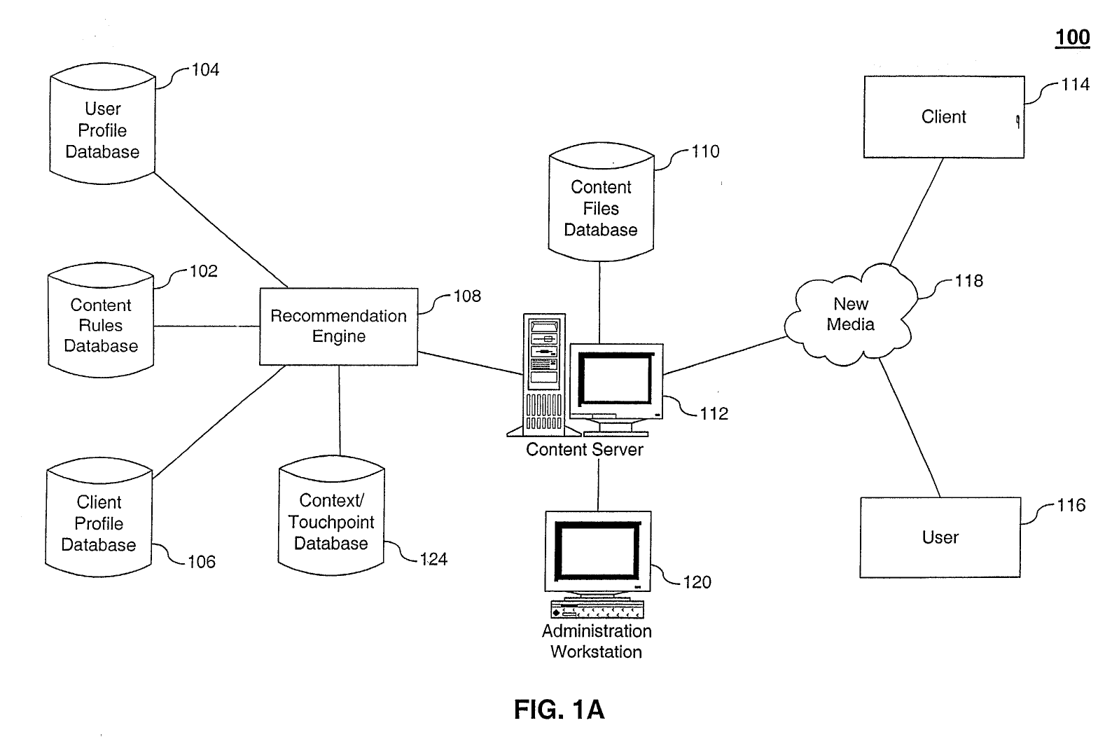

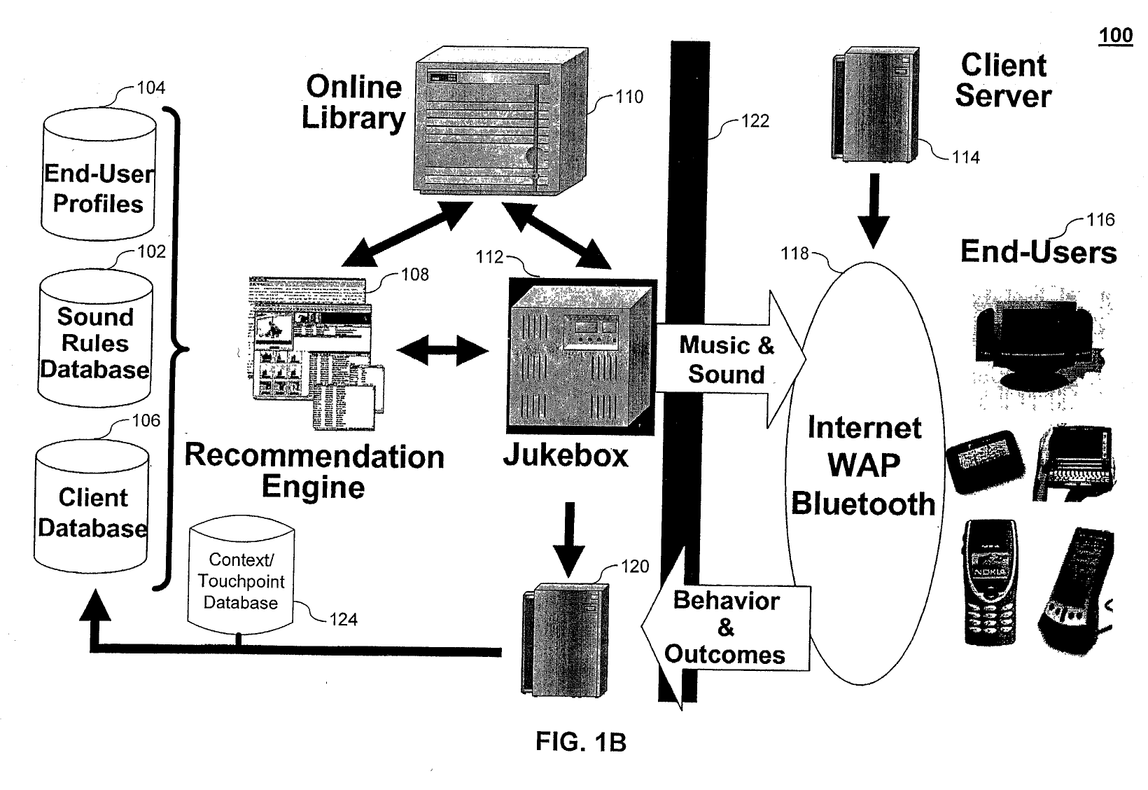

Referring to FIG. 1A, a block diagram illustrating the physical architecture of a content experience management (CEM) system 100, according to an embodiment of the present invention is shown. FIG. 1A also shows connectivity among the various components of system 100. The embodiment of FIG. 1A represents the ASP model of the CEM tool.

The CEM system 100 includes a number of databases 102-106. More specifically, CEM system 100 includes a content rules database 102, an (end) user profile database 104, a client profile database 106, and a context/touchpoint database 124, which are each explained in more detail below. The databases 102-106 and 124 are connected to a recommendation engine 108, which serves as the “back-bone” (i.e., the CEM processing tool) of the present invention. The “front-end” (i.e., content delivery) of the system 100 would be provided by a content server 112. The content server 112 is also connected to a content files database 110 which stores the actual content files that will be eventually selected and delivered by CEM system 100.

In an embodiment of the present invention, the recommendation engine 108 and content server 112 are SUN Ultra workstations running the SunOS™ operating system. In another embodiment, recommendation engine 108 and content server 112 are IBM™ or compatible personal computer (PC) workstations with an Intel® Pentium® III processor running either the Windows NT™ operating system or the BSD Unix operating system.

The content server 112 is further connected to a new media communication protocol 118 which serves as the communications medium between the ASP and the ASP's client(s) (e.g., e-commerce business) 114. The same medium allows communication between the client 114 and the end user (i.e., consumer) 116. While only one client 114, and only one user 116 are shown in FIG. 1A for ease of explanation, it will be apparent to one skilled in the relevant art(s) that the CEM system 100 may support a plurality of clients 114 who in turn conduct e-commerce or other communication activities with a plurality of users 116.

As will be also apparent to one skilled in the relevant art(s) after reading the description herein, the end users 116 would interact with clients 114 via one or more new media devices at one or more touchpoints. For example, the new media communication protocol 118 may be the Internet (i.e., TCP/IP) where e-commerce activities are conducted between the Web site of client 114 and the end user 116. In such an embodiment, the user 116 utilizes a device such as a PC (e.g., an IBM™ or compatible PC workstation running the Microsoft® Windows 95/98™ or Windows NT™ operating system, Macintosh® computer running the Mac® OS operating system, or the like), or any new media processing device including, but not limited to, a desktop computer, laptop, palmtop, workstation, set-top box, interactive television, gaming console, personal data assistant (PDA) or other handheld device, mobile phone, kiosk or the like.

The CEM system 100 also includes an administrative workstation 120 connected to the content server 112. This workstation can be used by personnel of the CEM ASP to upload, update, and maintain subscriber information (e.g., logins, passwords, etc.) and content-related data and rules for each of the clients 114 that subscribe to the CEM system 100. The administrative workstation 120 may also be used to monitor and log statistics related to the content server 112 and the system 100 in general. Also, the administrative workstation 120 may be used “off-line” by subscribers 114 of the CEM system 100 in order to enter configuration data and rules, as described below, in order to customize CEM system 100 performance. This data is eventually stored in the databases 102-106 and 124 as also described in detail below.

Components 102-112, 120 and 124 of the CEM system 100 (i.e., those components that the ASP would have as part of their infrastructure), as will be apparent to one skilled in the relevant art(s), are connected and communicate via a wide or local area network (WAN or LAN) running a secure communications protocol (e.g., secure sockets layer (SSL)).

Referring to FIG. 1B, a block diagram illustrating the physical architecture of the CEM system 100, according to another embodiment of the present invention is shown. FIG. 1B also shows connectivity among the various components of system 100. The embodiment of FIG. 1B also represents the ASP model of the CEM tool, but where the content is specifically audio.

Accordingly, the like reference numbers indicate identical or functionally similar elements from FIG. 1A.

The content server 112, in an embodiment where the new media communication protocol 118 may be the Internet (i.e., TCP/IP), is a Web server process running at a Web site which sends out Web pages containing content in response to Hypertext Transfer Protocol (HTTP) remote requests from subscribers 114. That is, the server 112 (‘jukebox”) would provide (and dynamically deliver) specific audio content from the online music library 110 to clients 114 based on heuristics (i.e., rules, variables, and/or selection algorithms or other rankings or weightings) as described herein. This audio content can then be sent to users 116 during the course of e-commerce activities/communications between the user 116 and client 114.

The components of the CEM system 100, as shown in FIG. 1B, are divided into two regions—“inside” (left side) and “outside” (right side). The components appearing in the inside region refer to those components that the ASP would have as part of their infrastructure in order to provide the tools and services contemplated by the present invention. As will be apparent to one skilled in the relevant art(s), all of components “inside” of the CEM system 100 are connected and communicate the WAN or LAN running a secure communications protocol (e.g., SSL).

The connection to the new media communications protocol (e.g., Internet) 118, which includes the WWW, however, is through a firewall 122. The firewall 122 serves as the connection and separation between the LAN or WAN, which includes the plurality of network elements (i.e., elements 102-112, 120, and 124) “inside” of the LAN or WAN, and the global Internet 118“outside” of the LAN or WAN. Generally speaking, a firewall is a dedicated gateway machine (e.g., a SUN Ultra 10) with special security precaution software. It is typically used, for example, to service Internet 112 connections and dial-in lines, and protects the cluster of more loosely administered network elements hidden behind it from external invasion.

Firewalls are well known in the relevant art(s) and firewall software is available from many vendors such as Check Point Software Technologies Corp. of Redwood City, Calif.

It should be understood that the particular embodiments of the CEM system 100, as shown in FIGS. 1A-1B, are for illustrative purposes only and do not limit the present invention. For example, while separate databases (i.e., databases 102-106, 110, and 124) are shown in FIGS. 1A-1B for ease of explanation, it will be apparent to one skilled in the relevant art(s) that the CEM system 100 may utilize databases physically located on one or more computers which may or may not be the same as engine 108 or server 112, as applicable. In an embodiment of the present invention, these databases can also be mirrored for fault tolerance purposes. In yet another embodiment, system 100 can contain separate databases 102-106, 110, and 124 for each of its clients 114 or categories of touchpoints.

More detailed descriptions of the CEM system 100 components, as well their functionality and inter-functionality with other CEM system 100 components, are provided below.

Example Content Intelligence Databases

The construction of the databases 102-106 and 124, according to one embodiment of the present invention is structured to contain content both rules, and user profiles, client data profiles, and context/touchpoint profiles, respectively. In this embodiment, the objectives of a client 114 can be defined according to the expected and/or desired experience paths of the touchpoints accessed by the end-users 116. In an alternative embodiment, the objectives of the user 116 can be defined according to the expected and/or desired experience paths of the particular touchpoints that they desire in their relationship with clients 114.

In traditional media, selection and use of audio content in a touchpoint, say, for example, television, can be used to alter the consumer's experience while viewing an advertisement or other programming. Thus, a similar approach is used for new media. However, the interactivity of such new media must be accounted for and exploited.

According to one embodiment of the present invention, a four-stage content intelligence process is employed to define the rules implemented to determine the optimal content for a specific touchpoint and/or user and/or client (e.g., a client's brand and/or product). While the content intelligence process is described in terms of the four-stage process explained below, this is for convenience only and is not intended to limit the present invention. In fact, after reading the following description, it will be apparent to one skilled in the relevant art(s) how to implement the following invention in alternative embodiments.

For example, the four-stage process can be executed by an ASP providing the CEM system 100 of the present invention:

(1) Receiving information from client 114 that includes information about the company, the brands and products of the client 114; parsing that information into categories based on the filters and flags for that type of product and/or type or brand and/or type of market; and prioritizing the brands and products based on the objectives, weighed objectives or intents of the client 114 and/or user 116.

(2) Determining rules based on those objectives and/or intents such that the client's direction is defined; determining touchpoints to be accessed by the client 114; and determining the user 116 that accesses those touchpoints.

(3) Selecting content based on the determinations of stage (2); implementing the use of the selected content; and monitoring the affects of the use of the selected content (see control flow 300 described below).

(4) Modifying the rules, content, client objectives and/or intent, and touchpoints based on the feedback obtained from the monitoring of stage (3) (see control flow 400 described below).

Rules can be structured in a binary fashion (e.g., yes/no, selected/deselected). Alternatively, rules may be prioritized based on either a weighted or linear or non-linear scale or weighting or any combination thereof, and the results of the construction process include a scoring process such that certain rules are either applied before other rules and/or certain rules are allowed to deselect and/or remove (i.e., override) other rule(s).

In one embodiment of the present invention, rules can be structured to select content that is appropriate to the objectives of either client 114 or user 116. Some exemplary outcomes that result from the application of rules resulting from the rule and profile construction process, include without limitation:

If a content file is conceptual and speaks to emotions, then the content file helps to grow brand values;

If a content file is personally experienced, then the content file helps to grow brand experience;

If a content file is rich, memorable and easily recognizable, then the content file helps to grow brand differentiation;

If a content file is evolutionary and changes over time, then the content file helps to grow brand evolution;

If a content file is highly flexible and has many facets, then the content file helps to grow brand architecture;

If a content file is engaging and guiding, then the content file helps to grow brand preference;

If a content file is a universal language, yet culturally specific, then the content file helps to grow brand geographic reach; and

If a content file is deployed to touchpoints where visuals are not, then the content file helps to grow brand extension beyond the visually-oriented touchpoints.

In one embodiment, filters are based on the strategic objectives of the client 114, such as conveying brand values or objectives (e.g., reliability or performance). In another embodiment, flags are based on tactical objectives of the client 114, such as the factors associated with stability and/or performance. For example, the performance filter can lead to the flags for factors such as speed, cornering ability, agility, etc. In other words, filters are the criteria for constructing and selecting rules and profile factors, and flags are the factors, also known as meta-tags and tags, which categorize content files with attributes.

In an embodiment of the present invention, one or more of the databases 102, 104, 106, 110, and 124 are implemented using a relational database product (e.g., Microsoft® Access, Microsoft® SQL Server, IBM®, DB2®, ORACLE®, INGRES®, or the like). As is well known in the relevant art(s), relational databases allow the definition of data structures, storage and retrieval operations, and integrity constraints, where data and relations between them are organized in tables. Further, tables are a collection of records and each record in a table possesses the same fields.

In an alternate embodiment of the present invention, one or more of the databases 102, 104, 106, 110, and 124 are implemented using an object database product (e.g., Ode available from Bell Laboratories of Murray Hill, N.J., POET available from the POET Software Corporation of San Mateo, Calif., ObjectStore available from Object Design, Inc. of Burlington, Mass., and the like). As is well known in the relevant art(s), data in object databases are stored as objects and can be interpreted only using the methods specified by each data object's class.

As will be appreciated by one skilled in the relevant art(s), whether the databases 102, 104, 106, and 110 are object, relational, or even flat-files would depend on the character of the data being stored by the ASP. The recommendation engine 108 contains specific code logic to assemble components from any combination of these database models, to build the required answer to a query. In any event, the server 112, client 114, user 116, and/or administration workstation 120 is unaware of how, where, or in what format such data is stored.

Furthermore, it should also be understood that the mnemonics reflecting the factors presented herein (e.g., in the Tables shown herein), which highlight the functionality and other advantages of CEM system 100, are presented for example purposes only. The software architecture of the present invention is sufficiently flexible and configurable such that the recommendation engine 108 may make selections of audio content within the CEM system 100 using factors (and thus, mnemonics) other than those presented in the tables shown herein.

While the CEM system 100 is described in terms of the specific databases, detailed below, this is for convenience only and is not intended to limit its application. In fact, after reading the following description, it will be apparent to one skilled in the relevant art(s) how to implement the following invention in alternative embodiments (e.g., by providing databases for non-corporate and/or non-profit entities, and product types and/or virtual products implemented within products to enhance that product (e.g., characters or products within a video game)).

Example User Profile Database

User profile database 104 contains both user profiles and user rules (i.e., a combination of personal information, as well as general information, such as demographic, and psychographic.) As described below, various factors can be used to structure the rules and aid in the rule selection process. The rule selection process is used to correlate users by the profiles populated by the execution of the selected rules. In one embodiment of the present invention, a user's profile is accessed to filter the content available for use at a particular touchpoint.

In another embodiment, a rule is constructed based on the matching of behavioral influences (e.g., something thrilling, information, etc.) with an advertisement that seeks to promote these influences in relation to the focus of the advertisement (e.g., thrill seeker, knowledge seeker, etc.). In an alternate embodiment, the user profiles can contain information, received directly from the user 116 (i.e., surveys, etc.) that pertains to the experience of users 116 with a brand and/or product of client 114. Such user profiles would provide similar brand experience information as described herein, although from a different source other than client 114.

An objective of embodiments of the present invention is to construct rules that are strategically implemented so that content matches the client's 114 objectives and values in a way that resonates with the needs and aspirations of the users 116 (i.e., their customers). The objectives, values, needs, and aspirations are therefore illustrated by the factors utilized by the CEM system 100.

Some exemplary factors used in constructing rules to be stored in user profile database 104 are shown below in TABLE 3.1.

TABLE 3.1
EXEMPLARY FACTORS UTILIZED IN USER RULES

| | | | | Least Favorite |
|---|---|---|---|---|
| Age | Life Stage | Content Profile | Favorite Content | Content |
| 15-20 | | | Rap, electric guitar, | |
| 20-25 | | Harder, more | rock, fireworks, ambient | |
| 26-30 | Searching for | aggressive, more | city sounds | Country music, |
| | Answers | purposeful | | easy listening |
| 31-35 | | Natural world with | Waterfall, baby | |
| 36-40 | Growing self- | remnants of upbeat | sleeping, techno, rock | Rap, techno, |
| 41-45 | awareness | music | | classical |
| 46-55 | | | Children laughing, soft | Angry rock, |
| 56-65 | Mature and | Natural world and | jazz, classical laughing, | metal, loud TV |
| 66-75 | Comfortable | calm sounds | soft jazz, classical | commercials |

TABLE 3.1 reflects that users 116 are grouped according to age and the content for those users is selected and/or filtered based on age. While the factors shown in TABLE 3.1 are described in terms of the age and life stage, this is for convenience only and is not intended to limit the scope of user rules. In fact, after reading the following description, it will be apparent to one skilled in the relevant art(s) how to implement additional user rules in alternative embodiments.

TABLE 3.2 shows a listing of factors that can be grouped into a category for use in constructing rules. The factors shown in TABLE 3.2 are not exclusive and additional factors can be utilized. Furthermore, as one skilled in the relevant art(s) would recognize, not all the factors need to be utilized in the construction of any given rule.

TABLE 3.2

USER FACTORS
Age
Location
Personality Type
Temperament
Aggressive/Passive Indicator
Time of day (situational)
Weather
Location (Work/Home)
Job
Date
Weather at Location
Purchase History
Relevance Feedback from user (passive or interactive)
Likes and Dislikes

Additionally, rules can be implemented alone or in groups with or without regard to specific information about a given client and/or user and/or piece of content.

In one embodiment of the present invention, information gathered from the monitoring of user responses can be used to re-determine the rules applied in constructing a user profile.

Furthermore, the feedback processes implemented from the monitoring of the response of users can be applied to client and content profiles.

For example, in one embodiment, users' responses that fail to meet the objectives of a client trigger modification of the content rules such that similar content (e.g., the same type of song or other content) is not selected by the recommendation engine 108 for those users at future touchpoints.

In a further embodiment, users 116 can be provided with a GUI at the touchpoint in order to provide feedback to the selected content. In a further embodiment of the present invention, a user's profile can be modified so that disliked content can be avoided regardless of client 114 or touchpoint.

In another embodiment of the present invention, a user 116 can purchase from client 114 at one touchpoint while the content selected is monitored. A future touchpoint, client 114 can provide the same or similar content in a process that overrides existing user profile information.

In yet another embodiment of the present invention, a user's 116 profile can be altered to prioritize similar content to similar products or co-branded products depending on the satisfaction of client objectives.

While the construction of rules is described in terms of the embodiments above, this is for convenience only and is not intended to limit the construction and modification of rules to those circumstances. In fact, after reading the following description, it will be apparent to one skilled in the relevant art(s) how to implement further rules and modify them in alternative embodiments.

Example Content Rules Database

Content rules database 102 is constructed similarly to the user profile database 104 as described above. Content rules are constructed from factors in a similar manner as user rules as described above. In one embodiment, content rules provide definite information about the types of content files available and the usage parameters associated with those content files.

In one embodiment, content (available from a content database and/or library) can be profiled with a number of factors as shown in the content usage column of TABLE 3.3. Additional factors are available and viable. For instance, content factors, in the case of audio, include: style, tempo, melody, genre, volume, voice, lyrics, moods, emotions, etc. as shown below in TABLE 3.9.

As shown in the TABLE 3.3 below, example content mapping parameters are illustrated. In one embodiment, content brand management processes are used to construct rules that properly map content to touchpoints based on factors associated with them. In one embodiment, content rules are constructed to enable a high level of reach, control, and flexibility for clients as they can alter rules based on their objectives, touchpoints, and the feedback that is obtained from the user 116.

TABLE 3.3
Example Content Mapping

| Content Usage | Experience Path (for Touchpoint) |
|---|---|
| Environmental | Attention/Awareness |
| Background | TV Ad |
| Ambient | Radio Ad |
| Product Sound | Banner Ad |
| Mechanical Sound | Knowledge/Information |
| Designed Sound | Interactive kiosks |
| Engineered Sound | Web site (corporate/brand) |
| Identification | Selection/Choice/Preference |
| Sound Logo | In-store display |
| Tags | Music on hold |
| Jingle | Automated messaging |
| Score | Web over phone |
| Sound Design | Action/Purchase |
| | Web site (e-commerce) |
| | Retail spaces |
| | Use/Interaction |
| | Products |
| | Offices |
| | Public spaces |
| | Transportation |
| | Restaurants |
| | Feedback/Loyalty |
| | Promotional CDs |
| | Events |

The examples of content mapping of Table 3.3 are shown with respect to sound and music, but as one skilled in the relevant art(s) would recognize from the teachings described herein, content mapping is not limited to this application.

In an embodiment of the present invention, content usage can be categorized to allow for a layering of profiles or rules. For example, environmental sounds can include background and ambient sounds, while identification sounds include sound logos, tags, jingles, scores, and sound designs, and while products include mechanical sounds, engineered sounds, and designed sounds. Additional categories will be apparent to one skilled in the relevant art based on the teachings described herein.

TABLE 3.4 shows some example content usage rules. As described herein, rules are constructed to determine the proper content to send to a touchpoint.

As shown in TABLE 3.4, according to an embodiment of the present invention, content rules can be constructed to remove from the selection process certain content so that a user and/or touchpoint will not have that content available to it. In a further embodiment, content rules can be structured so that certain content rules are prioritized and/or weighted for certain touchpoints.

In a further embodiment, a user's 116 responses are monitored and content usage rules that rely on factors determined by feedback events are implemented to alter the content selected.

For example, the depth within a Web site's shopping Web pages can be monitored and feedback given into the process of modifying content rules.

TABLE 3.4
EXAMPLE CONTENT USAGE RULES

No mixing of: tempo, background, other content properties/values
Vocals/No Vocals
Volume
Length of Track/Event
Content appropriate to bandwidth
Match classes of content to classes of events
Minimum number of events
Profile guides based on: priority, product, service, touchpoint
Depth within touchpoint (media usage relative to content already used)
Content properties (cue time, loopable, sharp ending, etc.)

In one embodiment of the present invention, the content rules database 102 can be configured via a GUI that provides for the selection and de-selection of the rules described herein. Additionally, rules can be grouped such that groups of rules can be selected and deselected.

According to embodiments of the present invention, the process of determining and selecting rules as described herein is aided by a GUI. In one example, a GUI is provided by the recommendation engine 108 and/or the administration workstation 120.

Example Client Profile Database

The client profile database 106, as described above, provides client profiles constructed from the application of rules in a similar manner as described above. In one embodiment of the present invention, defined behavioral influences, as shown in TABLE 3.5, are correlated to content which has factors that define it as corresponding appropriately.

TABLE 3.5

| BEHAVIOR INFLUENCES | RESONANT EXPERIENCE |
|---|---|
| (EXAMPLES . . . ) | (CONTENT TO . . . ) |
| Thrill seeker | . . . create thrilling experience |
| Knowledge seeker | . . . deliver/point to information |
| Price driven | . . . guide to good deals/sales |
| Service driven | . . . deliver service (e.g., narration) |
| Style driven | . . . music communicates the spirit |
| | of the band |
| Transaction driven | . . . encourage transaction |
| Relationship driven | . . . create a sense of belonging and |
| | community |

The CEM system 100 can construct processes for rule construction that help to build and transform a brand and/or product and/or client 114. These processes, similar to the four-stage process described above, provide the rules that structure the CEM system 100.

TABLE 3.6 shows a listing of brand information categories that illustrates some examples of brand information, categories, and examples. TABLE 3.6 further illustrates content brand information factors, which include some example objectives, impressions and touchpoints as describe herein.

TABLE 3.6

| | |
|---|---|
| BRAND INFO | CONTENT BRAND INFO |

| | | |
|---|---|---|
| Brand Attributes | Objects | Touchpoints |
| Innovation, reliability | Education | Banner Ad |
| Market Segment | Entertainment | CD |
| Business to Business (B2B) | Experiential | Display |
| Business to Consumer (B2C) | Health | Kiosk |
| Industry | Information | Music on Hold |
| Technology, automobile | Interaction | Offices |
| Products | Navigation | Products |
| Computers, cars | Purchase | Public Spaces |
| Distribution Channel | Safety | Radio Ad |
| Direct | | Retail |
| retail | Impression | Signage |
| | Durability | Transportation |
| | Impact | TV ad |
| | Elasticity | Web site |

In one example, a client 114 in a business to consumer (“B2C”) market segment with the objective of providing an image and presence of safety would see the appropriate content to convey that message. In another example, a client would seek the selection of the safety-objective content for each given touchpoint.

TABLE 3.7 shows a listing of example outcomes according to embodiments of the present invention. In one embodiment of the present invention, outcomes are quantified in the monitoring and feedback processes as described herein. The results are added to the appropriate profile.

While the discussion here is with respect to client profiles, the example outcomes, as well as other outcomes, can be implemented in any of the profiles (e.g., user 116 demographic, psychographic, or behavioral information can be included for the determination of outcome success within a client profile, and vice versa). Furthermore, the outcomes can be projected based on the rules constructed and/or the outcomes can be updated based on the results obtained from the feedback steps described herein.

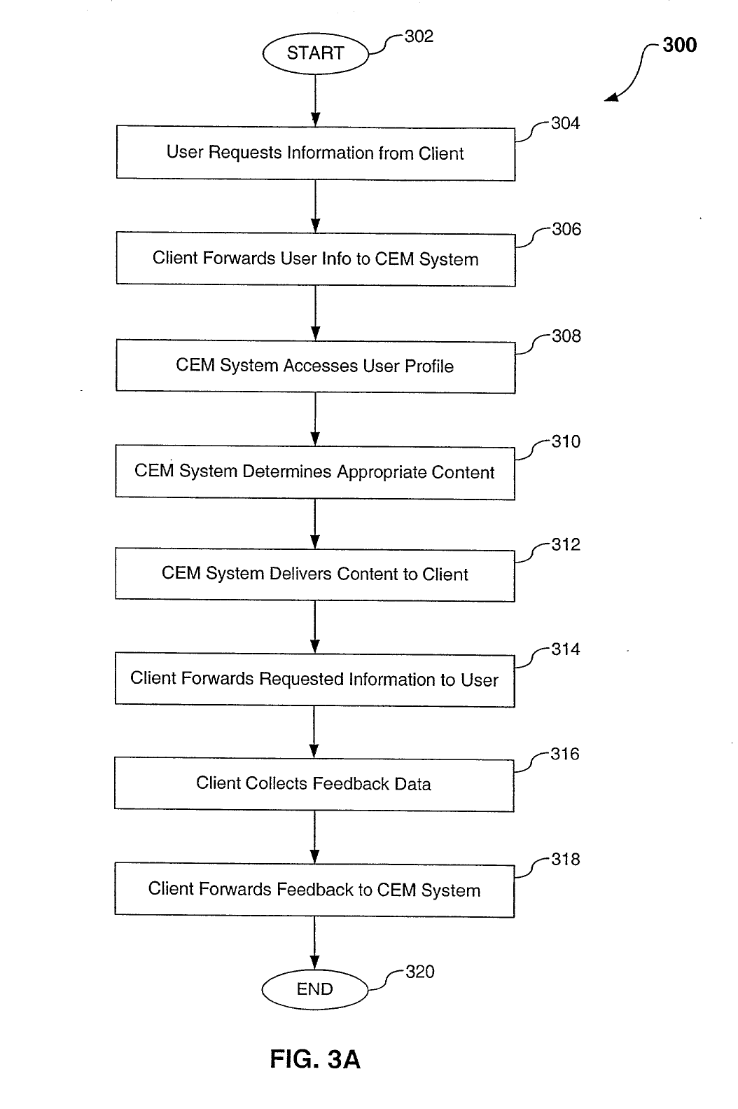

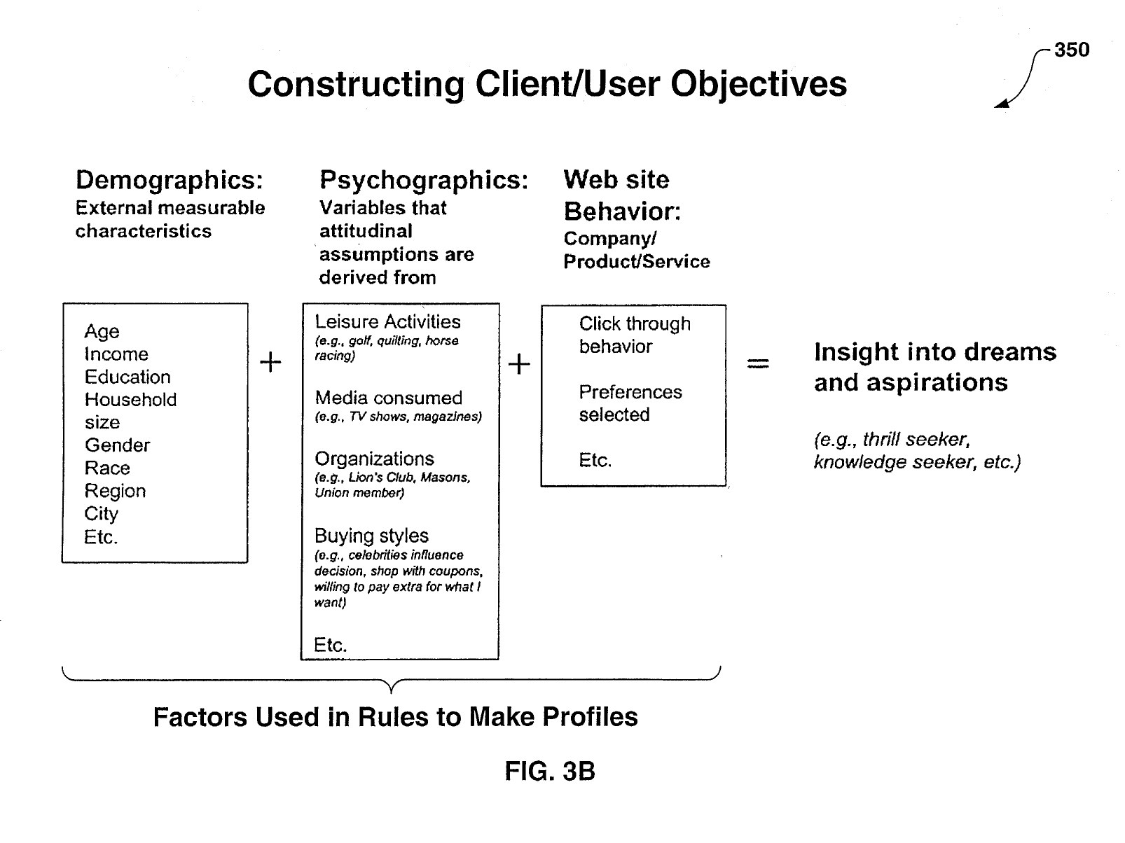

In yet another embodiment, outcome values are projected and added to the client profile so that client objectives can be measured. For example, if the user's length of stay was shorter than that defined in the outcome provided by the rule that constructed the client profile, then, as described in further detail with reference to FIG. 3A, the rules can be modified to alter the value assigned to that factor in the client profile or to alter the type of music to better match the amount of time of the user's 116 stay or to increase the length of the stay.

TABLE 3.7
Example Outcomes
Length of stay
Purchasing
Quantity
Selection
Locations Browsed
Location of exit/departure
Locations of Mouseover/Eyeball Activity
Locations of Clicks/Selections
Frequency of Accesses
Content Delivered
Learning
Sharing

TABLE 3.8 shows a list of example brand rules that can be applied to a client profile to determine the factors and values to apply. In one embodiment, a client profile may be constructed using a rule that limits the selection of content to their own specific content. For example, specific content that forms a library with the same theme to which the client desires to be identified.

In another embodiment, a client profile can be constructed using brand rules that limit the type of touchpoints from which to access. In yet another embodiment, a client profile can be constructed such that content palettes (i.e., families of related sounds that convey themes or are grouped by themes) are selected that group content for delivery based on the touchpoint and/or user 116 and/or combination of touchpoint and user 116.

TABLE 3.8
CLIENT 116 - BRAND RULES

Selection of Content and/or Rules
Type of Touchpoint
Product Class
Category
Nationality of Brand
Geographic Use
Brand Attributes
Target Market
Style Guide (principles and practices)
Medium of Touchpoint (environment)
Music Selection/Attributes
Trademarks Usage
Brand Essence
Distribution Channel

As previously discussed, a client profile can be altered by the feedback provided to the CEM system 100 so that the client profile reflects touchpoint events (e.g., product sales, Web pages viewed, etc.). From the perspective of the user 116, the touchpoint alters the experience at successive touchpoints in a meaningful way (i.e., furthering and/or altering brand content recognition).

TABLES 3.8.1 and 3.8.2 illustrate example client data used to construct client profiles for different clients 114. These examples are provided to aid in the understanding of the profiles constructed by the CEM system 100 and are not intended to limit them to the illustrated fields and/or values.

TABLE 3.8.1
EXAMPLE CLIENT DATA FOR A HARDWARE VENDOR

| Content | | | | |
|---|---|---|---|---|
| Usage | Touchpoint | Description | Brand/Product | Goal |
| Logo | Commercial | Slower tempo | PC chips, modems, | Increase brand |
| | | Techy | Plug-in cards | awareness and drive |
| | | Conservative | | consumer demand |
| | | Simple | | |
| Score 1 | Retail/tradeshow | Mid tempo | New chips | Engage consumer |
| | | Simple structure | (products), Web | and communicate |
| | | Rhythmical | access | product benefit |
| | | elaboration of logo | | |
| Score 2 | Web site | Faster tempo | e-business | Raise interest and |
| | | Cutting edge | | encourage Web site |
| | | Complex sound | | exploration |
| | | design | | |
| Score 3 | Commercial | Licensed music | Family of chips | Enhance visuals and |
| | | | | communicate |
| | | | | product and brand |
| | | | | benefit |

TABLE 3.8.2
EXAMPLE CLIENT DATA FOR A GAME CONSOLE VENDOR

| Content | | | | |
|---|---|---|---|---|
| Usage | Touchpoint | Description | Brand/Product | Goal |
| Ad score 1 | Commercial | Techy | Games | Bring to life the |
| | | Electronic | | playing experience |
| Ad score 2 | Commercial | Techy | Games | Bring to life the |
| | | Electronic | | playing experience |
| Logo | Commercial/ | Sound effect | Games | Brand awareness |
| | Product | Funny voice | | Irreverent |
| | | “in your face” | | |
| Score | Web site | Techy | Games | Bring to life the |
| (short) | introduction | Electronic | | playing experience |
| Score | Web site | Techy | Games | Bring to life the |
| (long) | introduction | Electronic with | | playing experience |
| | | voice | | |
| Score | Web site loading | Techy | Games | Bring to life the |
| | | Electronic | | playing experience |
| Product sounds | Products/Games | Techy | Games | Feedback |
| (multiple) | | Electronic | | Action |

In one embodiment of the present invention, users 116 can have their user profile altered based on purchasing history at one touchpoint, so that the experience at another touchpoint is altered.

In another embodiment of the present invention, a client 114 can structure the implemented client rules to ensure that a brand's identity is kept distinct from that of competing brands through the use of dissimilar content.

In yet another embodiment of the present invention, a client 114 can monitor the user 116 through a touchpoint, such as a Bluetooth-enabled telephone, and alter the user profile so that a user 116 does not have the same content selected (e.g., the same brand jingle or advertisement).

While the brand rules are described in terms of the TABLES 3.8.0, 3.8.1, and 3.8.2, this is for convenience only and is not intended to limit them. In fact, after reading the following description, it will be apparent to one skilled in the relevant art(s) how to implement additional rules in alternative embodiments.

Example Context/Touchpoint Database

Preferably, the context/touchpoint database 124 contains context-centric profiles and rules for one or more touchpoints or groups of touchpoints. In one embodiment of the present invention, the profiles contain one or more of the factors described herein (e.g., location of touchpoint (especially when a touchpoint is mobile), type of touchpoint, and time of day) as well as additional information that defines the type of content that can be used by the touchpoint.

In another embodiment of the present invention, the context/touchpoint database 124 provides the CEM system 100 with rules for deploying content files based on the specific touchpoints and/or environment (factors for touchpoints) in which the content files are being used. An example of this embodiment of the present invention includes each touchpoint and/or environment being represented in the context/touchpoint database 124 with a specific set of rules that will have a significant influence in determining appropriate content selection. More specifically, context/touchpoint rules can be structured in a similar manner as described herein with respect to the other databases so that the time, date, weather, geography, holiday/special event, location of the touchpoint, access to the touchpoint, formality of the location of the touchpoint, frequency of use of the touchpoint, type of touchpoint, technical or bandwidth constraints of the touchpoint, and other factors can influence the context/touchpoint profile construction and thereby alter the content files selected by the CEM system 100.

In another embodiment of the present invention, the context/touchpoint database 124 can be implemented in a serial or redundant manner by clients 114 or users 116. For example, a client 114 can utilize the context/touchpoint database 124 of CEM system 100 to provide a filter the content files selected for use by the client's 114 touchpoints.

In an alternative embodiment, the client 114 can utilize the CEM system 100 along with the context/touchpoint database 124 to provide the rules and profiles that filter the content files selected for use by the client's 114 advertisements on the touchpoints determined by context/database 124.

Example Content Database

The content files database 110 can contain a library of proprietary music and audio files (e.g., music, sound effects, voice narrative, jingles, etc.) owned by the CEM application service provider. In an alternative embodiment of the present invention, the library can contain music and audio files that are licensed from commercial organizations and/or those in the public domain.

In another alternative embodiment of the present invention, content file database 110 includes factor/flag information for each content file.

In yet another alternative embodiment of the present invention, the process of delivering content files to clients 114 and users 116 can be altered such that content files are delivered en masse, from time to time, so that similarly selected content can be stored locally or for user 116 and/or client 114 review and further deployment.

In a further embodiment of the present invention, a client 114 can include references/indicators/resource locators to one or more content files to construct a soundscape for a particular brand and/or product. Soundscapes include one or more content files. Soundscapes can be easily accessed, managed, and distributed to multiple touchpoints. According to an embodiment of the present invention, soundscapes can be stored locally by a client 114 for distribution to a user 116. Alternatively, soundscapes can be integrated into a touchpoint (e.g., a Web site, kiosk, entertainment system, etc.).

In yet a further embodiment, a user 116 can be allowed to access the soundscapes via a search process implemented in CEM system 100. For example, recommendation engine 108 can provide this functionality. In another example, a user 116 is able to access soundscapes at a touchpoint (i.e., an entertainment system) on an airplane of a client's 114 airline that offers integrated content solutions to their users 116.

TABLE 3.9 shows some example content profile information. The category of each factor is shown in bold and provides the rule construction process with variables to which process can filter the content in an operation to select one or more pieces of content.

| Style | Voice | Texture | Instrument |
|---|---|---|---|
| Alternative | Child | Noisy | Accordian |
| Ambient | Group | Rich | Banjo |
| Classical | Man | Silent | Bass |
| Comedy | Woman | Thin | Big Band |
| Country | Environment | Moods | Brass |
| Dance | Ambient | Bittersweet | Cello |
| Folk | Animal | Celebration | Clarinet |
| Funk | Natural | Dark | Flute |
| Jazz | Lyrics | Determined | Guitar Acoustic |
| Latin | Yes | Disappointment | Guitar Electric |
| Lounge/Cocktail | No | Dreamlike | Harmonica |
| Multi-style | N/A | Driving | Horn |
| New Age | Languages | Easy | Jazz Combo |
| Orchestral | African | Humorous | Latin Rhythms |
| Soundtrack | Languages | | |
| Pop | Arabic | Inspirational | Marimba |
| R&B | Chinese | Melancholy | Orchestra |
| Rap | Creole | Mysterious | Organ |
| Reggae | English | Quiet | Percussion |
| Rock General | Far Eastern | Reflective | Piano |
| | Languages | | |
| Rock Hard | Farsi | Romantic | Rhythm |
| | | | Section |
| Rock Light | Finnish | Smooth | Rock Bank |
| SFX | French | Strength | Saxophone |
| Sound design | French (West | Suspense | Sitar |
| | African) | | |
| Techno | Gaelic/Celtic | Tragic | Strings |
| | Language | | |
| World | German | Triumph | Synth |
| Tempo | Greek | Uniting | Synth/Sound |
| | | | Design |
| Fast | Hebrew/Yiddish | Upbeat | Trumpet |
| Medium | Indian Languages | Instrument Type | Violin |
| Medium to Fast | Indigenous | Electronic | Voiced |
| | Languages | Instrument | |
| Other | Italian | Environmental | Woodwind |
| Slow | Japanese | Instrumental | Xylophone |
| Slow to Fast | Latin | Voiced | Elasticity |
| Slow to Medium | Middle Eastern | Length | Difficult to |
| | Languages | | Arrange |
| Various | Native American | Unlimited | Easy to arrange |
| Melody | None | Ownership | N/A |
| No | Olde English | Licensed | Harmony |
| Yes | Portuguese | N/A | No |
| N/A | Russian | Original | Yes |
| | Spanish | | N/A |
| | Swedish | Impact | |
| | Turkish | No, Yes, N/A | |

The terms of TABLE 3.9 are for convenience only and are not intended to limit the application of the content rules. In fact, after reading the following description, it will be apparent to one skilled in the relevant art(s) how to implement the present invention in alternative embodiments using other content profile information.

Example Application Service Provider Model

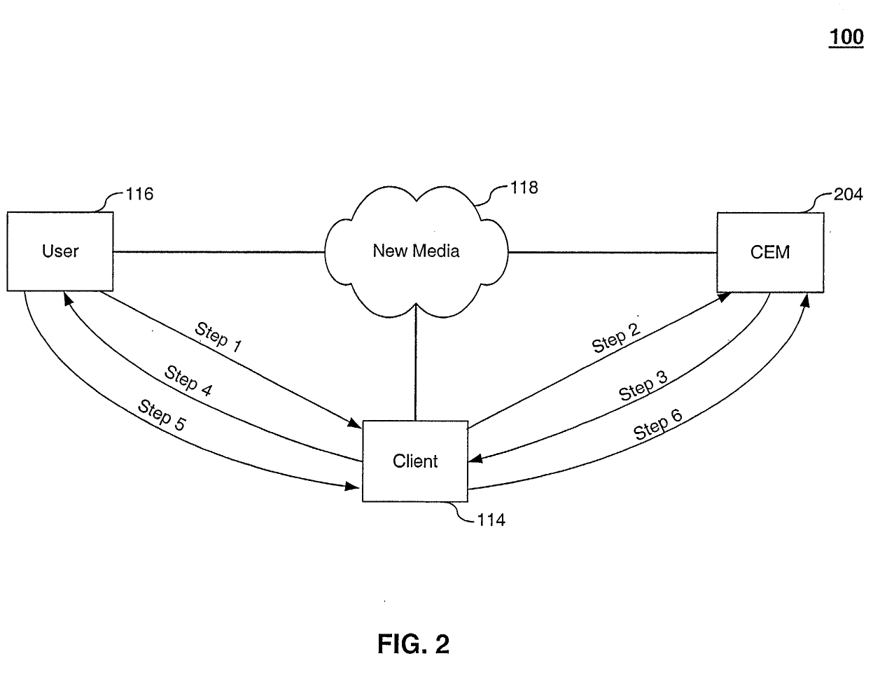

Referring to FIG. 2, a block diagram of the CEM system 100, according to the ASP embodiment of the present invention, is shown. Within FIG. 2, six process step arrows are shown to illustrate the control flow of the CEM tool of the present invention.

In step 1, a user 116 utilizes a device such as a personal computer (PC) (e.g., an IBM™ or compatible PC workstation running the Microsoft® Windows 95/98™ or Windows N™ operating system, Macintosh® computer running the Mac® OS operating system, or the like), or any new media processing device including, but not limited to, a desktop computer, laptop, palmtop, workstation, set-top box, gaming console, personal data assistant (PDA), mobile phone, or the like to access the Web site of client 114. This access would be via the Internet (i.e., TCP/IP as the new media communication protocol 118).

Client 114, in order to keep consumers engaged, communicate brand messages, develop consumer loyalty, cause or influence specific, targeted behaviors, and avoid targeted behaviors (inform, assure, learn, share, and/or energize), has access to a CEM facility 204 (i.e., the ASP's infrastructure which includes components 102-118, 120 and 124 of FIG. 1) via a subscription to a CEM ASP.

In step 2, the client 114 accesses the CEM facility 204 in order for the CEM system 100 to select the appropriate content (e.g., audio) to enhance the experience of the end user 116 while visiting the Web site of the client 114. This is done in order to provide the end user 116 with a resonant consumer experience and help the client 114 implement its branding strategies and produce sales.

In step 3, the CEM facility 204 returns the appropriate experience enhancing content (i.e., audio) to the client 114.

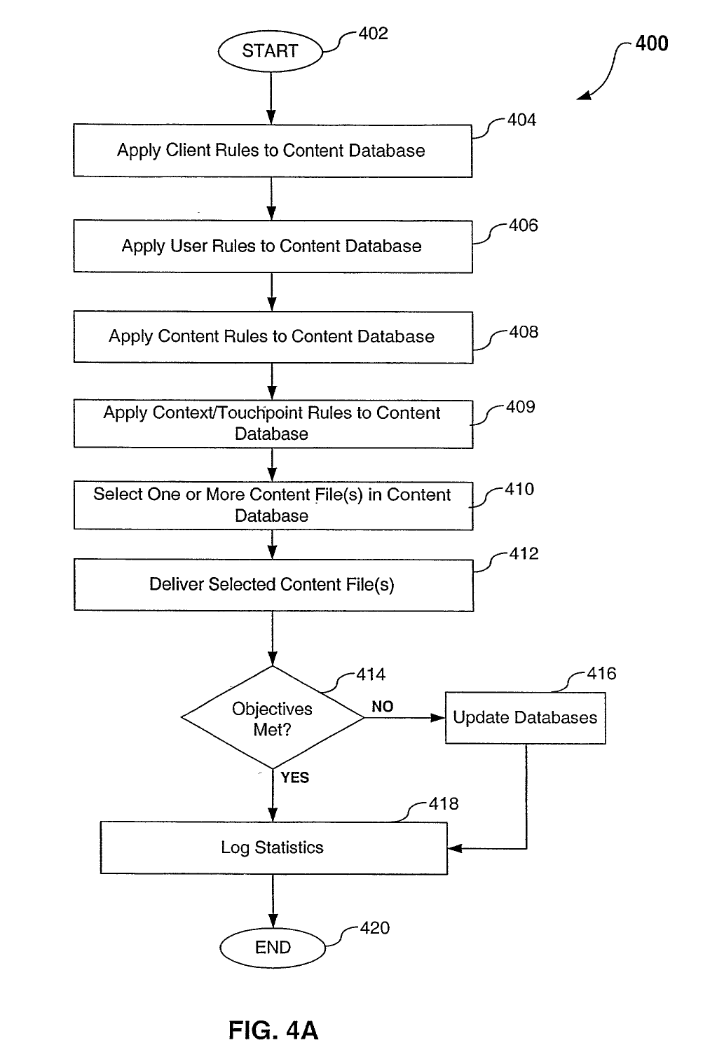

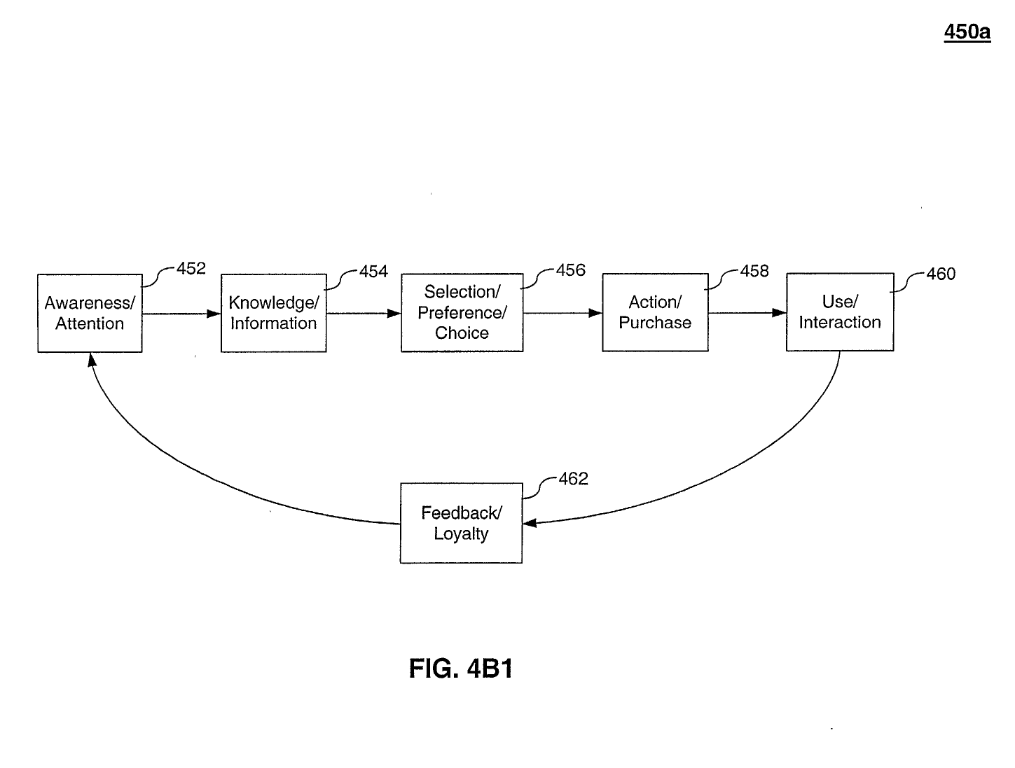

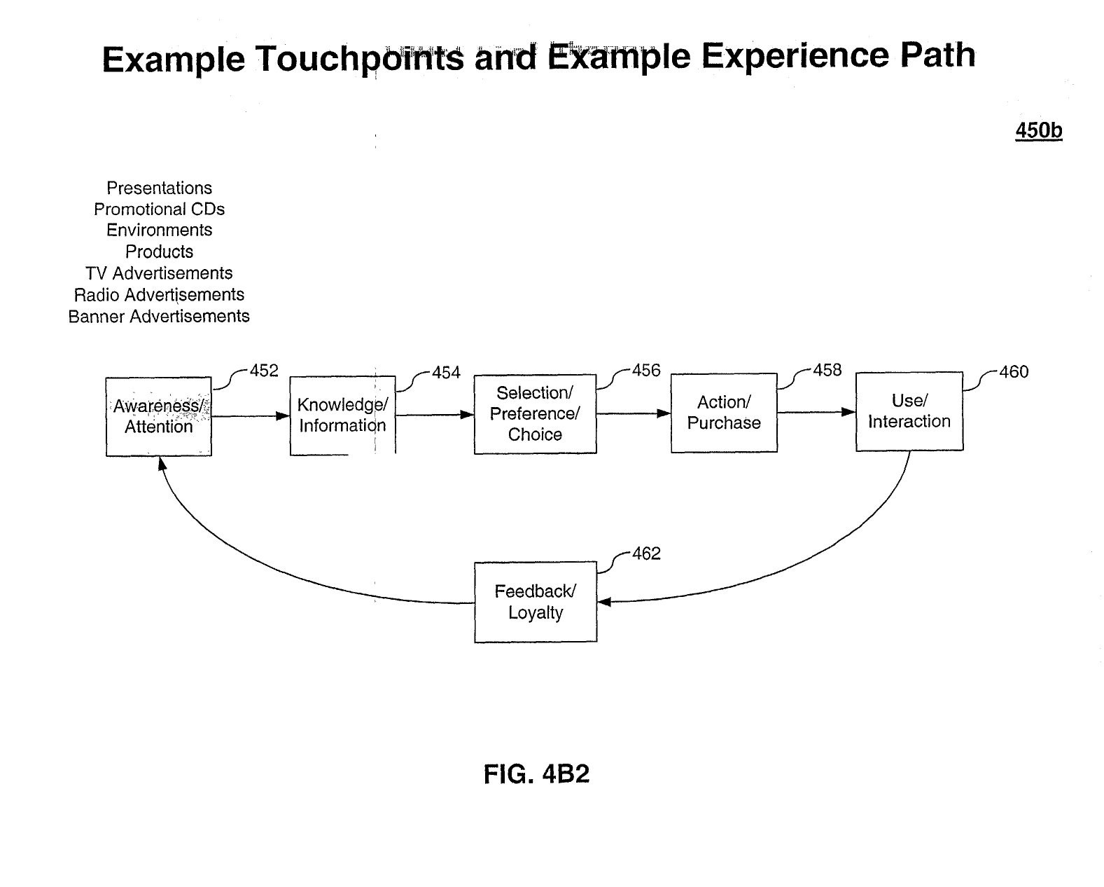

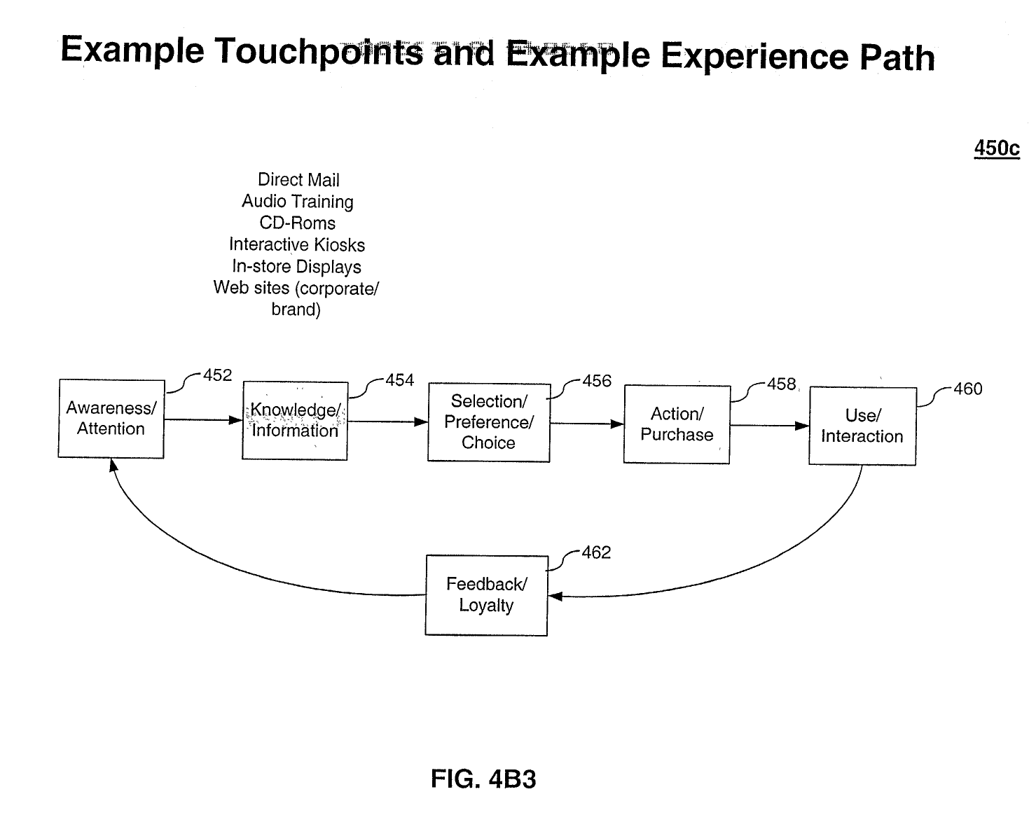

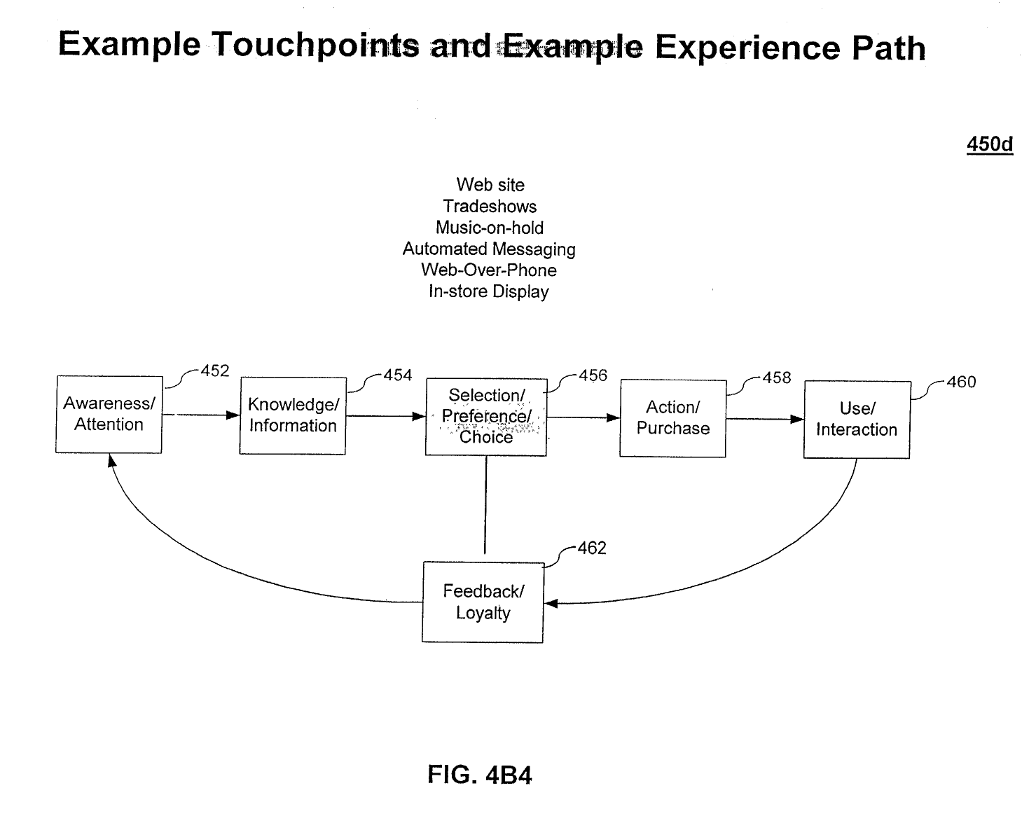

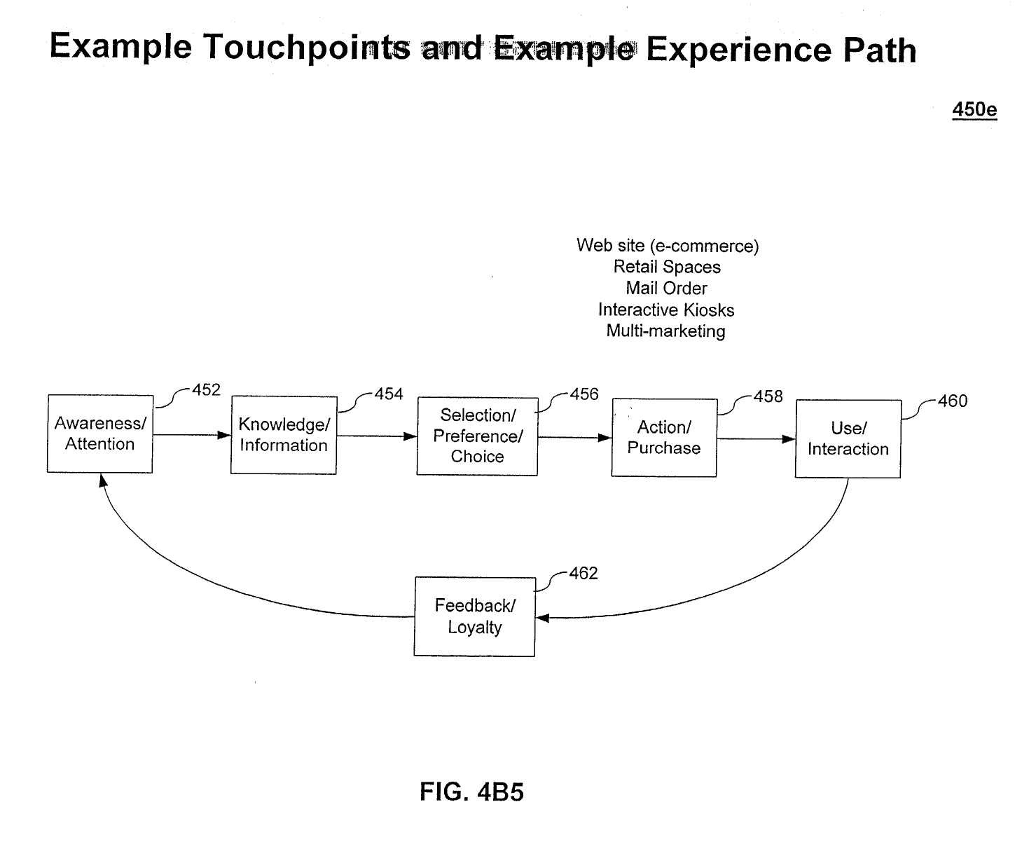

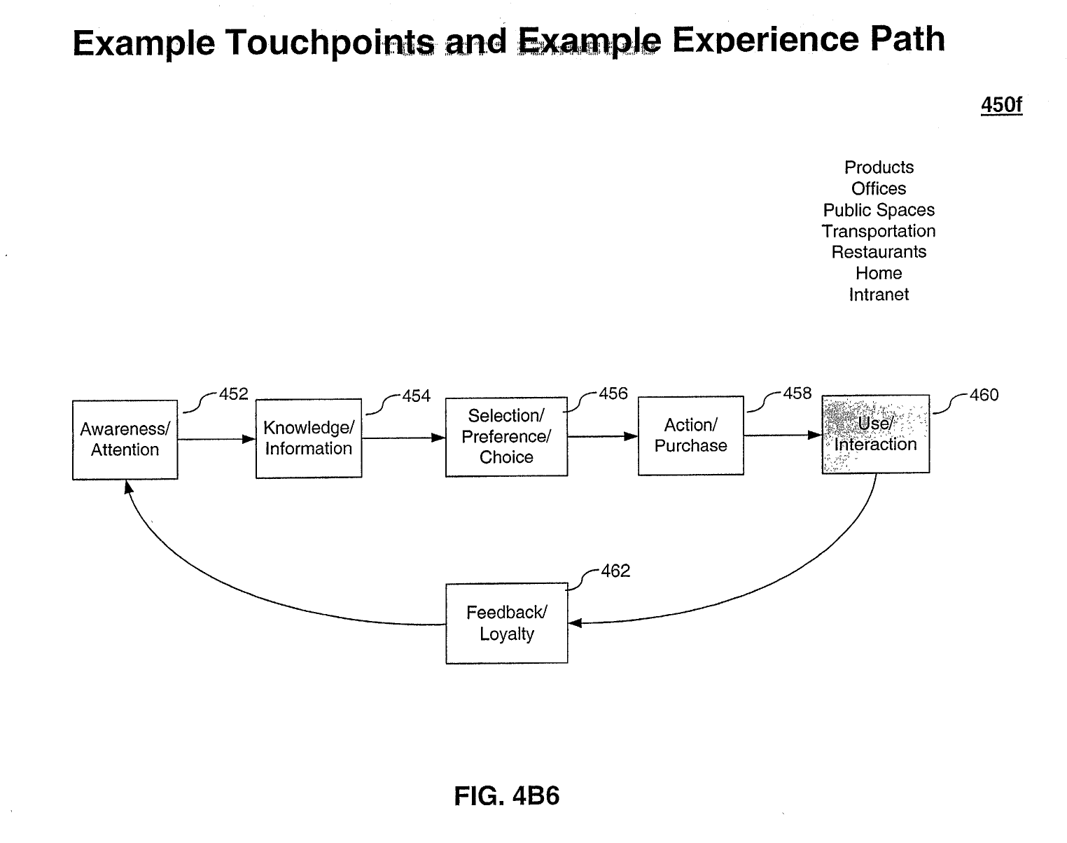

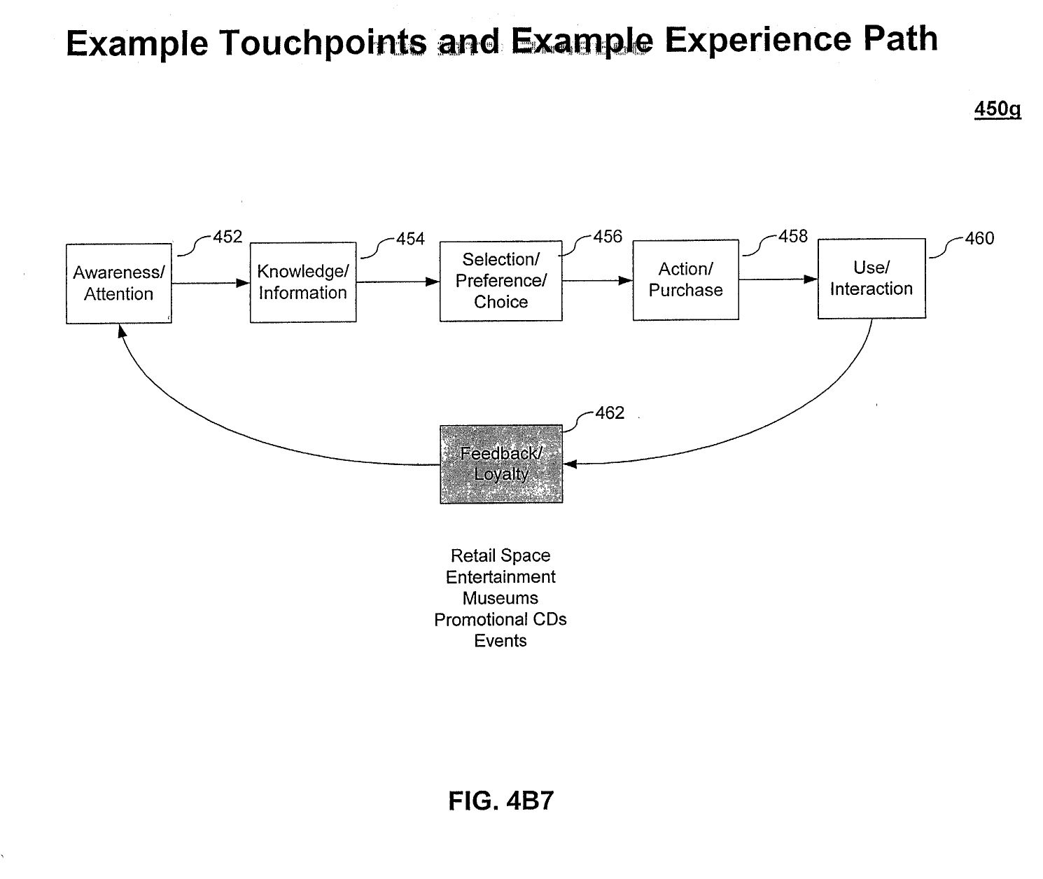

In step 4, the client 114 then forwards the selected content to the user 116. The selection process (and the rules applied in the selection process) is explained in detail below with reference to FIG. 4A.

In step 5, the reactions of the end user 116 (clicks, etc. as described in TABLE 3.7) to the content delivered are sent to the client 114 as “feedback data.” This feedback process is explained in detail below with reference to FIG. 4A.

In step 6, this feedback data is then sent to the CEM facility 204 in order for the recommendation engine 108 to refine its future content selection process (i.e., so the recommendation engine can “learn” what content works for what consumers 116) by updating the rules (or the application of existing rules) in the appropriate databases 102-106, and 124.

Referring to FIG. 3A, a flowchart depicting an embodiment of the operation and control flow 300 of the CEM system 100 of the present invention is shown. More specifically, control flow 300 depicts, in flowchart form, the example presented above with reference to FIG. 2 with particularized reference to individual CEM system 100 components. Control flow 300 begins at step 302, with control passing immediately to step 304.

In step 304, the user 116 request some information from a client 114. Such request may include a Web site visit (i.e., an HTTP request to display a Web page).

In step 306, the client forwards information related to the user 116 to the content server 112 of the CEM system 100. Such user information may be user specific (e.g., user login, preferences read from browser cookies, user profile, or group demographic information as described above with respect to database 104). In an embodiment of the present invention, a user 116, exploiting the fact that a business employs a CEM system, client 116 may submit user profile information to one or more clients 114 in order to facilitate the reception of content that meets their objectives.

In step 308, the recommendation engine 108 of the CEM system 100 accesses the user profile database 104 in order to retrieve the appropriate user profiles which will assist in the selection of the appropriate content.

In step 310, the recommendation engine 108 additionally accesses the content rules database 102 and the client profile database 106 (as explained below) in order to determine (i.e., recommend) the appropriate experience enhancing content (i.e., audio) to the client 114 for the particular end user 116.

In step 312, the CEM system 100 returns the appropriate experience enhancing content (i.e., audio) to the client 114.

In step 314, the client 114 then forwards the selected content to the user 116 as part of the original request for information in step 304. That is, a sonification of the requested information occurs. This selected (audio) content is aimed to keep the user 116 engaged, communicate the brand messages of client 114, develop consumer loyalty, cause or influence specific, targeted behaviors, and avoid targeted behaviors which all translate into increased sales for the CEM ASP's client 114.

In step 316, the client 114 collects the reactions of the end user 116 (clicks, mouse movements, outcomes, page depth, etc.) (see TABLE 3.7).

In step 318, the client 114 sends the feedback data to the CEM system 100 in order to update databases 102-106 and 124, as appropriate.

Control flow 300 then ends as indicated by step 320. As will be apparent to one skilled in the relevant art(s), flow 300 would be continually repeated as a user 116 browses the Web site of client 114.

It should be understood that control flow 300, which highlights the functionality, scalability, and other advantages of the CEM system 100, is presented for example purposes only. The architecture of the present invention is sufficiently flexible and configurable such that clients 114 and users 116 may utilize the CEM system 100 in ways other than that shown in FIG. 3A (and FIG. 2). For example, the CEM system 100 may provide the selected (audio) content directly to user 116 via a uniform resource locator (URL) link rather than delivery through the client 114.

Profile Resonance (Feedback)

Preferably, CEM system 100 is an outcome-focused and designed as an iterative process loop dedicated to constant improvement over time (i.e., if the audio selected by the engine 108 does not send the right message or elicit the intended behavior or emotion, then it is improved to achieve its intended purpose).

Referring to FIG. 3B, a block diagram 350 is shown. According to one embodiment of the present invention, block diagram 350 shows the application of factors grouped into categories which can be segmented in the user profiles for the Web site implementation described herein.

In one embodiment of the present invention, the post-content experience behavior of the user 116 is tracked and compiled by the client 114 to determine the effect of the content. The results are communicated to the CEM system 100 (e.g., to the recommendation engine 108). The results can include both behavior after receiving the content files and a baseline for either client 114 desired behavior and/or previously recorded and/or averaged behavior. The results can be made available to the client 114. Furthermore, the results can be used to alter the rule construction and application process for either or both the client 114 and user 116. These results can include things like length of stay was too short or user 116 did not click on at item.

Referring to FIG. 4A, a flowchart is shown that depicts an embodiment of an operation and control flow 400 of the rules application and feedback of the content experience management system of the present invention. Control flow 400 begins at step 402 and proceeds immediately to step 404.

In step 404, the client rules stored in client profile database 106 are applied to the content stored in content database 110. The rules stored in client profile database 106 described above are applied to the content files database 110. The effect of the application of these rules is to eliminate those content files that do not meet the criteria of the applied client rules. Thus, the resulting content files are those files that are somehow related or applicable to the profile of the client for which content files are being searched.

In step 406, the user rules stored in user profile database 104 are applied to the content files that resulted from step 404 above. The rules stored in user profile database 104 are described in greater detail above. The effect of the application of these rules is to eliminate those content files that do not meet the criteria of the applied user rules. Thus, the resulting content files are those files that are somehow related or applicable to the profile of the users for which content files are being searched.

In step 408, the content rules stored in content rules database 102 are applied to the content files that resulted from step 406 above. The rules stored in content rules database 102 are described in greater detail above. The effect of the application of these rules is to eliminate those content files that do not meet the criteria of the applied content rules. Thus, the resulting content files are those files that are appropriate for the user for which they are intended.

In step 409, the context/touchpoint rules stored in context/touchpoint database 124 are applied to the content files that resulted from step 408 above. The rules stored in context/touchpoint database 124 are described in greater detail above. The effect of the application of these rules is to eliminate those content files that do not meet the criteria of the applied context/touchpoint rules. Thus, the resulting content files are those files that are appropriate for the user 116 or touchpoint for which they are intended.

In step 410, one or more content files are selected from the group of content files resulting from step 408 above. Selection by the code logic executing on engine 108 may occur in a variety of ways such as random, chaotic or cyclical.

As will be apparent to one skilled in the relevant art(s) after reading the description herein, steps 404-409, in an embodiment, comprise a process of elimination. That is, the set of content files from database 110 which remain for engine 108 to choose from in step 410 is a set that results from the following intersection operation:

{Files that meet Client Rules}∩{Files that Meet User Rules}∩{Files that meet Content Rules}∩{Files that meet Context/Touchpoint Rules}

For example, database 110 may contain 1,000,000 pieces of audio content. Then, in step 404, the client brand rules stored in database 106 are applied and 250,000 pieces of audio content would remain. Then in step 406, the user rules stored in database 104 are applied and 75,000 pieces audio of content would remain. Then in step 408, the content rules stored in database 102 are applied and 1,250 pieces audio of content would remain. Then in step 409, the content rules stored in database 102 are applied and 50 pieces audio of content would remain. Then in step 410, engine 108 would select one of the possible 50 candidate pieces of content. This may be accomplished by determining if any previously selected (or some other global rule or selection algorithm) pieces of content are among the set of 50. If so, then the code logic within recommendation engine 108 would select from available remaining pieces of content.

In a step 412, the selected content file is delivered to the user.

In a step 414, it is determined whether the objectives of the client were met. The objectives of client 114 are described in greater detail above. The determination of step 414 can be accomplished by a routine located on CEM system 100 or a routine located on a computer of client 114. If the determination of step 414 is positive, then control flow proceeds to step 416. If the determination of step 414 is negative, then control flow proceeds to step 418.

In step 416, the rules in user profile database 104, content rules database 102 and client profile databases 106 are updated to reflect the new feedback information. This process is referred to as “relevance feedback” because it is feedback from user 116 regarding the relevance of the content file (e.g., sonified Web page) which was received. Relevance feedback, in this instance, is information of the nature that is stored within user profile database 104, content rules database 102, client profile database 106, and context/touchpoint database 124. That is, relevance feedback, in this instance, is information regarding the content preferences of users and content rules.

Relevance feedback can be garnered in a variety of ways. Client 114 can collect this information when user 116 is browsing the Web site of client 114. Client 114 can monitor user 116 during his visit of the Web site of client 114 and send this information back to CEM system 100. Alternatively, content server 112 or recommendation engine 108 can receive the relevance feedback from user 116. Regardless of the method through which relevance feedback is garnered, this information is used by the CEM system 100 to modify the rules of user profile database 104, content rules database 102 and client profile database 106 to reach the objectives of client 114.

In a step 418, statistics gathered during process 400 are logged (for possible later viewing on the administration workstation 120). These statistics are logged for the purpose of collecting and analyzing information regarding the experience of user 116. This information can be used to further the information in user profile database 104, content rules database 102, client profile database 106, and context/touchpoint database 124. In step 420, process 400 ceases.

Referring to FIGS. 4B1-4B7, flowcharts depicting an alternative embodiment of the operation and control flow 450a-g of the rules application and feedback operations of the CEM system 100 of the present invention are shown.

Referring to FIG. 4B1, flowchart, depicting an example experience path flow 450a according to an embodiment of the present invention, is shown. The flowcharts of FIGS. 4B2-B7 show the same example experience path flows 450b-g. As described herein, touchpoints can be provided with content through the use of selective processes. As described in the teachings herein, these selective processes provide for rule construction and selection of touchpoints so that users 116 are presented with content experiences that are coherent for the client 114.

Experience path flow 450a illustrates a number of steps that illustrate the operational progression of the experience path in terms readily associable with the touchpoints described herein. In one embodiment of the present invention, the experience path 450a progresses through the following steps: Awareness/attention step 452, knowledge/information step 454, selection/preference/choice step 456, action/purchase step 458, use/interaction step 460, and feedback/loyalty step 462. Upon reaching feedback/loyalty step 462, flow 450a returns to awareness/attention step 452.

Feedback/loyalty step 462 can alter the rules (or application of the rules by engine 108) and profiles of the databases 102-106, and 124 according to the embodiments described herein with respect to the monitoring, feedback, and outcome determination processes of the present invention.

Flows 450b-g provide example touchpoints that can be selected at each step in the experience path flow 450a. It should be understood that experience path flows 450a-g, which highlight the functionality, categories, and other advantages of the CEM system 100, are presented for example purposes only. The present invention is sufficiently flexible and configurable such that clients 114 and users 116 may utilize the CEM system 100 in ways other than those shown in FIGS. 4B1-B7.

Remote Content Management Model

As mentioned above, in an alternate embodiment of the present invention, a stand-alone application program is provided to clients, which serves as the content experience management system. The application program would provide similar functionality as described herein with reference to the ASP model mentioned above. Such software would allow companies to perform their own sonification and audio content management.

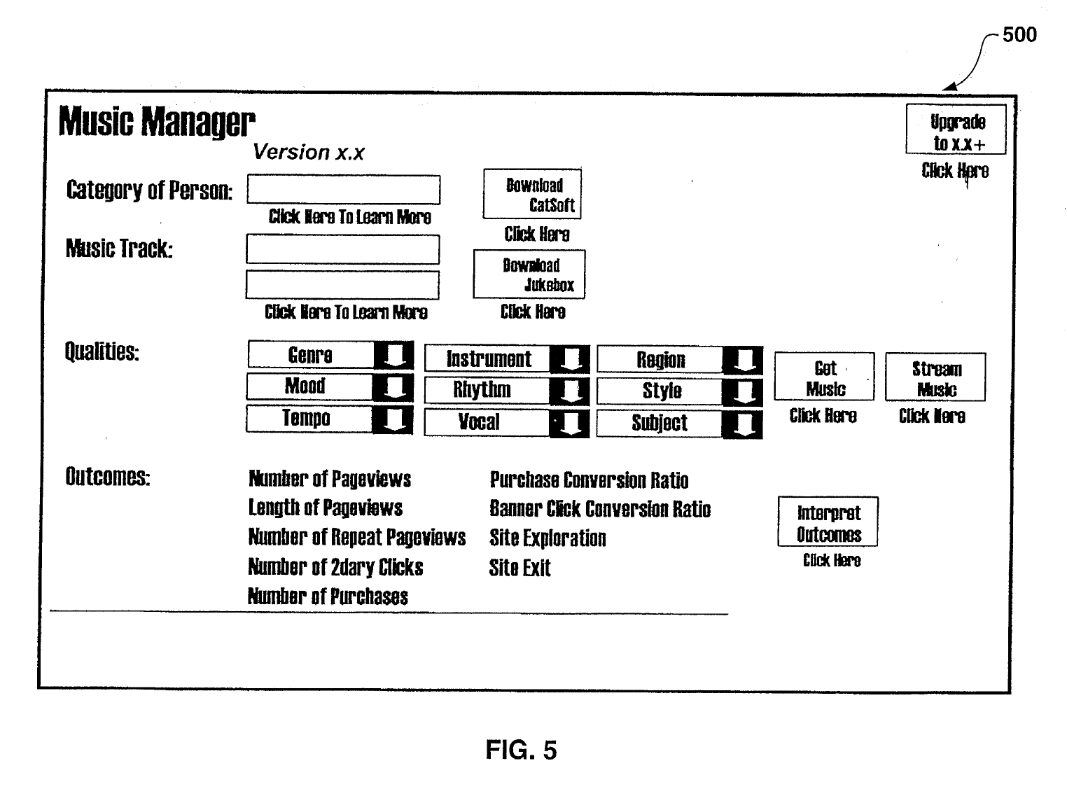

Referring to FIG. 5, a window or screen 500 shot generated by the graphical user interface in such a remote audio content management embodiment of the present invention is shown. Screen 500 includes a group of selections and text fields for interaction with a client, similar to client 114. The selections and text fields on the interface are provided to client 114 for specifying both the information regarding the content that will be provided to users, similar to users 116, and the objectives of client 114.

Window 500 allows the client 114 to choose the type of users 116 that will be receiving content, the type of music that client 114 chooses to send to users 116 and the qualities of the content that client 114 chooses to send to users 116. These selections include information that can be used by a system similar to the CEM system 100 to determine the content that will be delivered to users 116. In essence, the pull down menus of window 500 allow the client 114 to create rudimentary rules (similar to those stored in user profile database 104, content rules database 102 and client profile database 106 in the ASP model explained above with reference to FIGS. 1A-B) to effect the selection of the appropriate audio content. These rules can then be integrated into the relevant CEM databases. In order to integrate these rules, the application program of window 500 would require access to these databases. Furthermore, in order to access the audio files selected by client 114 in window 500, it would be necessary for the audio files to be locally available to the client 114. Alternatively, the client 114 could be given access to a remote database housing this information, similar to content files database 110.

Window 500 also includes a section for choosing the type of outcomes that are desired by the client 114. These selections include information that can be used by CEM system 100 to determine the effectiveness of its processes. That is, these selections provide a metric by which the processes performed by the CEM system 100 can be measured for performance, such as price points and/or sale. In addition, the window 500 includes a group of buttons that may be used when interacting with other portions of the interface. These buttons provide links to application programs or to separate portions of the instant application program that can provide assistance in making selections and entering information into the interface.

User Experience

The following embodiments of the present invention describe resonant content experiences that are delivered to end users 116 as a result of the processes performed by CEM system 100 as described herein. The content files referred to in the following sections would be supplied after the operation of control flow 400. As such, the content files provided to the user 116 as described in the following sections have situational significance to the user 116.

Web Site Sonification

For purposes of the following discussion, the following definitions will apply:

A Web page is a file written in a format that can be read by a Web browser. The format of a Web page is typically HyperText Markup Language (HTML) but can also be Java®, ColdFusion®, PERL or the like.

A “Web site” is a group of Web pages that are associated in some manner, such as geographically, categorically or contextually. A Web site is typically a group of Web pages providing information associated with a company, organization or educational institution.

A “Web page” object is an executable object existing on a Web page. This can include video, audio or movie files that can be executed by a user browsing the Web page. This can also include animation files such as Flash® or Shockwave® files.

A “link” is a symbol on a Web page that, when clicked by the user browsing the Web page, refers the user to another Web page or Web site.

A “mouse-over” is the act of passing a mouse cursor over a link, Web page object or other subject matter located on a Web page.

“Stickiness” is a metric used for measuring the ability of a Web page to retain (i.e., continue to engage) a user viewing the Web page.

In an embodiment of the present invention, resonant content experiences are delivered to users via a Web site. These experiences can serve to enrich the user's experience while visiting the Web site and to promote certain user behavior on the Web site. Content delivered to the user can heighten a theme or mood, which the Web site desires to inspire in the user. This can include the increasing of a sense of excitement, anticipation, inevitability or curiosity. Furthermore, content that is delivered to the user can promote certain behavior in the user. This can include such behavior as viewing certain Web pages or portions of Web pages, executing Web page objects, clicking on links to other Web sites or Web pages, purchasing products for sale on the Web site, and entering user information into a Web page.

Web Site Navigation

In an embodiment of the present invention, resonant content experiences are delivered to users 116 while navigating a Web site. Navigation of a Web site is the act of traversing Web pages and Web objects for the purpose of reaching a destination. This includes clicking links, moving a mouse cursor over Web page objects and moving back or forward between Web pages. Navigation of a Web site does not include the purposeful execution of a Web page object by a user for the purpose of experiencing content or information. In other words, navigation of a Web site includes the acts necessary to reach a Web page, not acts such as executing video or playing games.

Resonant content experiences can be delivered to users during Web site navigation in a variety of ways. In one embodiment of the present invention, audio can be delivered to the user as a result of a mouse-over. The mouse-over may prompt the temporary execution of an audio file. This can include the execution of an audio file related to the symbol. For example, if there is a mouse-over of a Web page object in the form of a checkered flag, the temporary sound of a quickly passing car can be executed.

The mouse-over may also prompt the permanent execution of an audio file. For example, a song or recurring beat can be executed as a result of the mouse over. This audio file can continue to play until another audio file is executed or the user navigates out of the current Web page. The execution of a permanent audio file can complement a currently existing audio file. For example, a percussion audio file may already be executing before the mouse-over occurs. Thus, upon the mouse-over, another audio file, such as a vocal sequence, can be executed. The execution of the vocal sequence can complement the percussion by adding depth to the music experienced by the user. In this example, a user can be encouraged to navigate over Web page objects and other Web page subject matter in order to experience the content that is delivered during a mouse-over. This can increase user navigation of a Web page and stickiness.

In another embodiment of the present invention, audio can be delivered as a result of mouse cursor location. The location of the mouse cursor on the Web page can affect the type or depth of audio that is delivered to the user. For example, a Web page can be configured such that locating the mouse cursor near the top of the Web page results in the execution of either a reduced number or no audio files (i.e., silence). In addition, if audio files are executed, they can be executed at a low volume. The Web page can further be configured such that locating the mouse cursor over the bottom of the Web page results in the execution of numerous or high volume audio files. In this example, a sense of clarity or simplicity can be conveyed to the user during navigation within the top of the Web page while a sense of completeness or complexity can be conveyed to the user during navigation of bottom of the Web page. This can affect user behavior on the Web site by encouraging a user to proceed navigation from the top to the bottom of the Web page. This can result in higher user retention of advertising information and thus, higher product sales.

In another embodiment of the present invention, audio can be delivered upon first access of a Web page or Web site. That is, audio can be delivered when the Web page being accessed is first displayed in the Web browser of the user or in the transition between Web pages. A standard banner advertisement can be also associated with the delivered audio. The delivered audio can be any audio file that is associated with the entity that is sponsoring the Web page or Web site. For example, the delivered audio file can consist of a sound logo associated with the sponsoring entity.

In another example, the audio file can consist of a sound that is associated with the product being sold, such as a car horn for an automotive product. In one embodiment, the delivered audio can be temporary or permanent. For example, the audio file can be a song or rhythm that is played continually or only for one cycle. Alternatively, the audio file can be an exclamatory sound such as a cymbal or a conga, which is played only once (for one note), or only for a limited period of time. This feature is advantageous because it enables a user to associate a sound logo with a product or company. This can lead to increased consumer recognition of products and thus, increased sales.

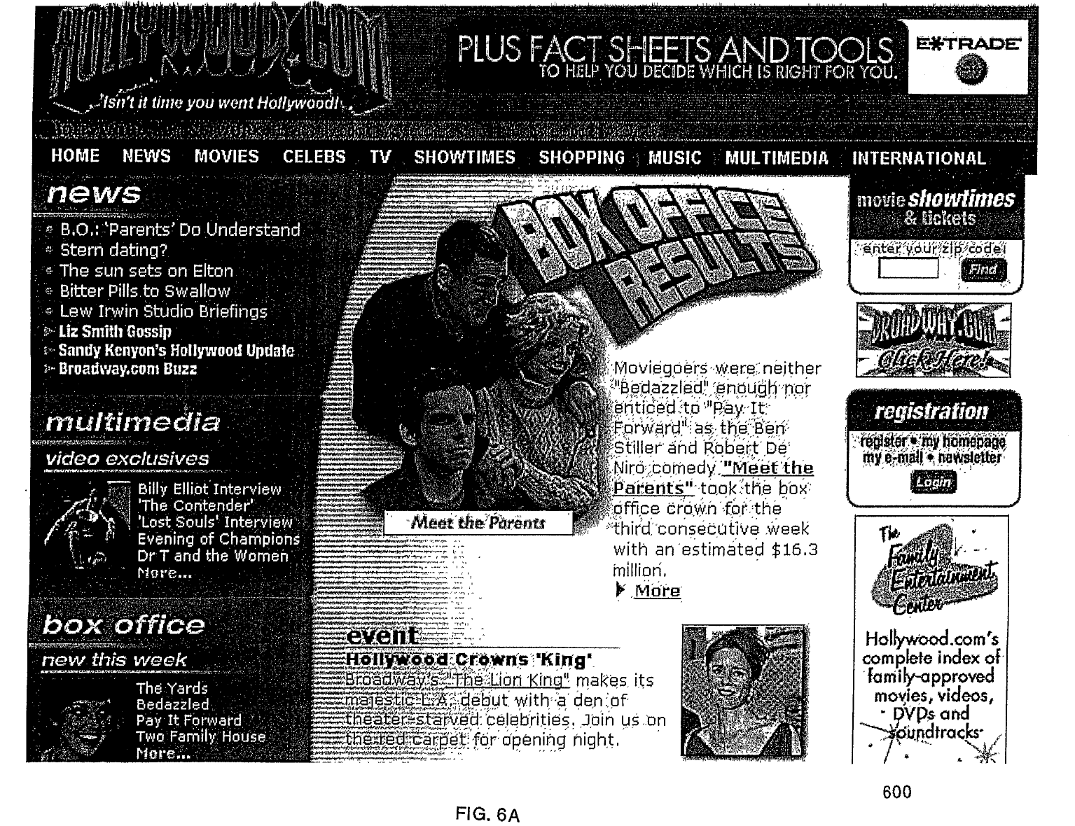

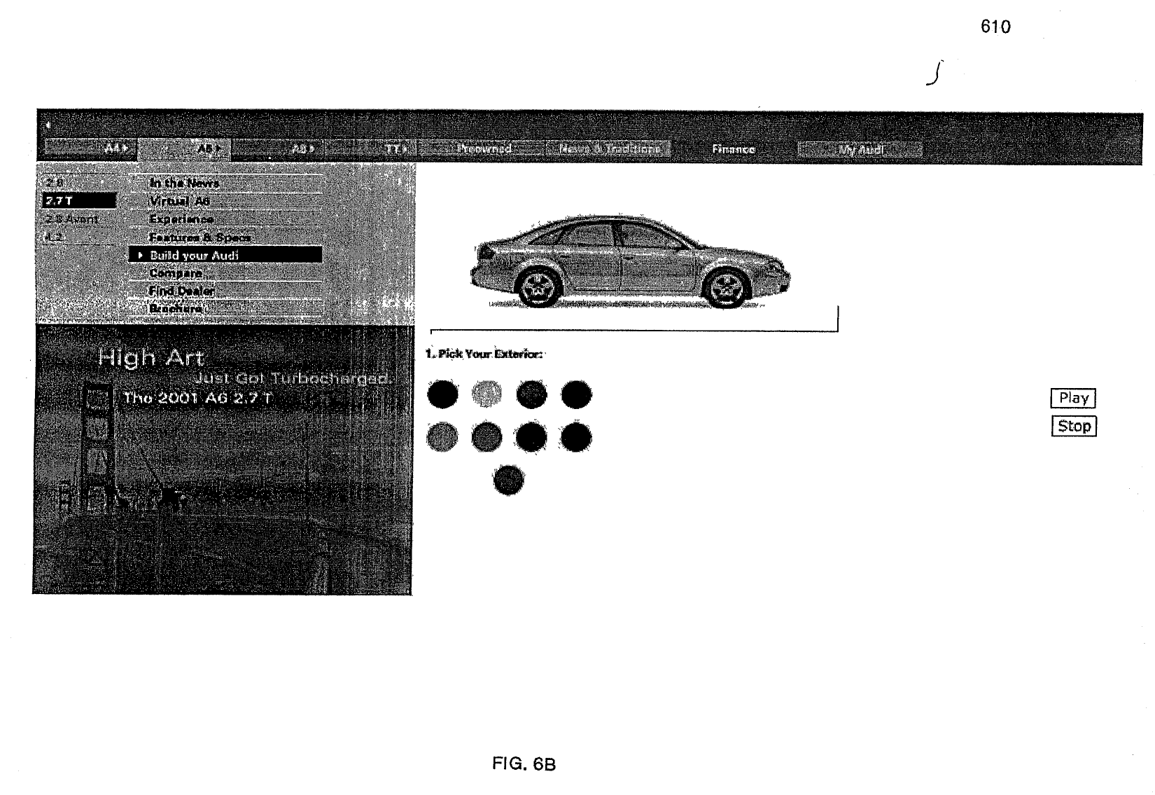

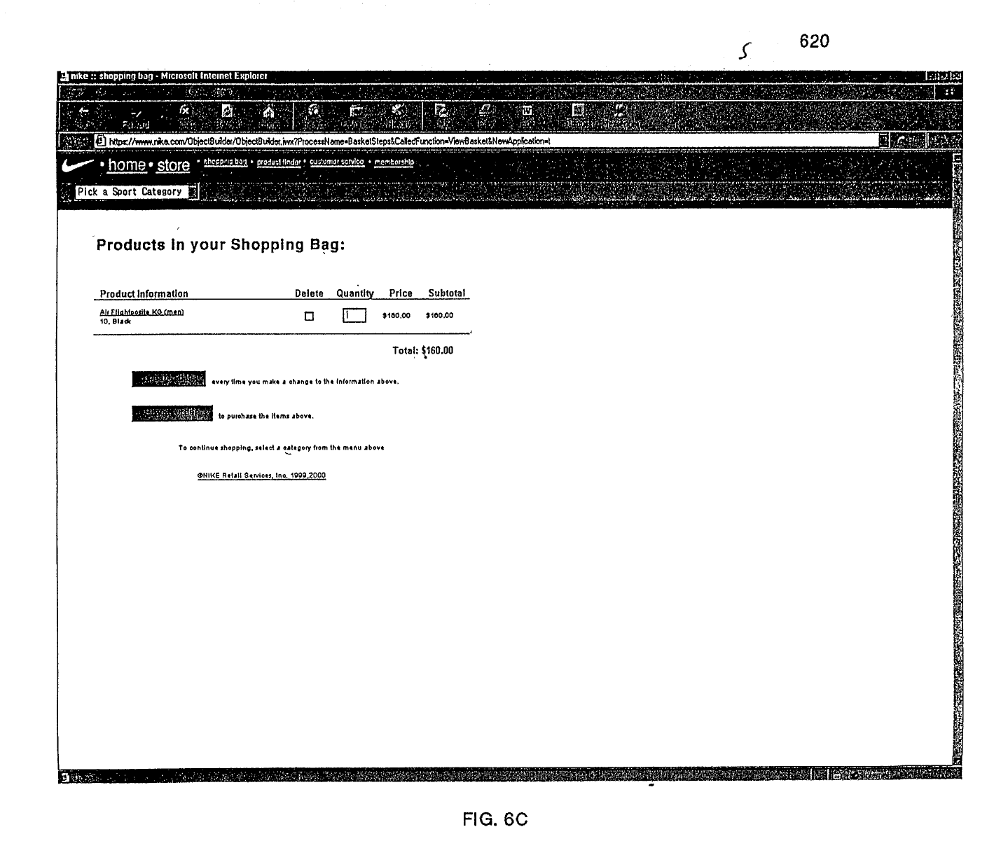

Referring to FIG. 6A, an exemplary window or screen shot 600 generated by the graphical user interface of the present invention in a content enriched, navigation embodiment is shown. Window 600 shows a Web page including numerous links and Web page objects. In this Web page, the links shown are associated with audio files. These sound files can be executed temporarily when a mouse-over occurs over each link. Thus, users 116 can experience a short sound when their mouse cursor travels over each link. Preferably, each sound file is unique and is somehow associated with the content that is available when the corresponding link is activated.

Also, window 600 shows an advertising banner at the top of the Web page. This advertising banner is associated with an audio file that is played when the Web page is originally displayed by the user's Web browser. Preferably, the audio file consists of a sound logo, which is associated with the entity that is sponsoring the banner advertisement and the corresponding audio file. Therefore, upon the opening and displaying of the Web page, the users 116 experience an audio file which they will eventually learn to associate with the sponsoring entity (and their brands). In an example where there are multiple sponsors of a Web page, the execution of an audio file associated with one sponsor can serve to highlight the presence of, or distinguish, that sponsor.

Interactive Build

In an embodiment of the present invention, resonant content experiences can be delivered to a user 116 during the purchase process on a Web site. In this embodiment, a user who is purchasing or potentially purchasing a product on a Web site can receive audio content which is related to the process or the stage of the process in which he is engaged. A user can receive content, which enhances and promotes the purchasing experience. For example, a user can receive a growing audio experience during the purchasing experience. In this example, the user interacts with the Web site during the purchasing experience. The interactions can include user selections regarding the product that is being purchased or potentially purchased. The interactions can also include the user entering personal information necessary for completing the purchase.

In this example, as the user accomplishes the various interactions with the Web site, a continual audio file is executed. That is, with each interaction accomplished, an additional continuous audio file is executed. Preferably, all audio files used in this process are associated such that they fit together musically. For example, all audio files may be of the same genre. Moreover, the audio files are selected such that the sequence of their execution is musically aesthetic. For example, a bass line is executed before vocals. The executed audio files guide the user through the purchase (i.e., “checkout”) process and encourage the user to complete the transaction.

At the completion of the first interaction, a continual audio file which is appropriate for the beginning of a process, such as a drum beat, is executed. At the completion of the second interaction, a continual audio file which is appropriate for the second stage of a process, such as a tambourine, is executed (in addition to, and overlaid over, the first audio file). This sequence continues through the entire process for the completion of each interaction. The culmination of this process is a mixture of audio files that, when heard together, are aesthetically pleasing and promote the product or the company sponsoring the Web site.

Referring to FIG. 6B, a window or screen shot 610 generated by the graphical user interface of the present invention in a content enriched, interactive build embodiment of the present invention. The figure shows one option in a series of options available to a user participating in a purchasing process on a Web site. In this figure, the user has already chosen previous options during the purchasing process. As these previous options were chosen, continual audio files were executed and a growing audio experience is delivered to the user. Likewise, when the user chooses an option from the Web page in the current figure, an additional continual audio file is executed and added to the audio experience.

The interactive build feature is beneficial because it enhances the user experience of purchasing a product on a Web site. This feature can promote the purchasing process by providing a resonant content purchasing experience, which is enjoyable and comforting. Furthermore, this feature can promote the stickiness of the purchasing process by providing an experience which users enjoy for reasons other than the product or service that is being purchased.

It should be understood that control flow described above is presented for example purposes only. The architecture of the present invention is sufficiently flexible and configurable such that users may navigate through the interactive build process in ways other than those described above.

User Delivery Examples

In an embodiment of the present invention, resonant content experiences can be delivered to users 116 during automatic information gathering and display. For example, resonant content experiences can be delivered to users while gathering and reading information from the Internet regarding a stock or other market. In this example, audio files can be executed when certain market events occur and are acknowledged by an application program. The sounds contained within the audio files can be associated with the market event that has occurred. TABLE 5.1 shows an exemplary list of market events that can be associated with audio files. In another embodiment of the present invention, the sound logo of a particular company can be played along with the event indication sounds listed in TABLE 5.1. One example of this is the execution of a “crash” audio file when the market value index dips below a threshold. Another example is the execution of a cash-register sound when the market index rises above a threshold.

TABLE 5.1
EXAMPLE MARKET EVENTS

52-week high
52-week low
trading volume above a threshold
trading volume below a threshold
dividend distribution executed
stock split executed
closing price above opening price
closing price below opening price
(strong) buy/sell rating given
target price achieved/surpassed
trade command pending
trade command executed
market opening (soon)
market closing (soon)
market value index above threshold
market value index below threshold

In an embodiment of the present invention, market events can be discerned with or without user interaction. That is, the determination of whether a market event has occurred can be performed by an application program with or without user interaction. For example, the following market events can be discerned with no user interaction: client 116 market opening or closing, market opening or closing soon, 52-week high for a particular stock, 52-week low for a particular stock, closing price above or below opening price for a particular stock, whether the stock has split and whether dividends have been distributed for a particular stock.

In another example, some market events require some user input into the application program. For example, for the market event indicating that the trading volume for a particular stock is below a threshold, the user would be required to input the threshold into the application program beforehand. This can be done via a user interface. The following market events can require user input: trading volume for a particular stock is above or below a threshold, target price for a particular stock has been achieved or surpassed and whether the market value index is above or below a threshold.

The feature associated with the sonification of market events is advantageous because it allows for greater transmittal of information. Whereas a standard market application program displays text that can become cluttered and hard to read, a sound-based market application program can convey information easily without requiring the user to read a display. This is beneficial because it allows a user to concentrate on other tasks besides a display and still receive market event information. Further, the audio content alerts the user to certain events and reinforces the existing visual display.

User Application Sonification

Exemplary Internet Browser Example

In an embodiment of the present invention, resonant content experiences can be delivered to users to convey inherent Web browser functions. Inherent Web browser functions include those functions performed by a Web browser that are associated with internal tasks, such as security verification. Inherent Web browser functions do not include navigation through Web pages and Web sites and execution of Web page objects. As such, a Web browser can be content enriched to convey information regarding the status or degree of inherent Web browser functions being currently performed. For example, an audio file can be associated with the security level of a Web site being browsed.

In this example, an audio file, appropriate to the function, is executed when the Web browser switches to security mode. The associated audio file can be the sound of a padlock being locked or closed. Further, an audio file can be executed when the user views a secure site. The associated audio file can be the sound of a padlock being unlocked or opened. Other inherent Web browser functions that can be sonified include: the sending/receiving of cookies or applets, automatic text completion/insertion, downloading of files, uploading of files and Internet connectivity.

Referring to FIG. 6C, an exemplary window or screen shot 620 generated by the graphical user interface of the present invention in a content enriched, Web browser embodiment is shown. Window 620 shows a standard Web browser including a symbol of a padlock in the lower right-hand corner. The padlock represents the security level of a Web site. When the user encounters a secure site, the padlock is rendered as if it were locked. When the user encounters a non-secure site, the padlock is rendered as if it were unlocked. Further, as described above, an audio file (varying in tune, pitch, frequency, etc.) may be executed when the security mode changes. The sound of a padlock being closed is executed when the Web browser enters into security mode and the sound of a padlock being opened is executed when the browser exits out of security mode. In an alternate embodiment, the sound can be varied (e.g., different audio content file or the same audio content file played at different volumes) depending on the bit-level of the encryption (e.g., 16-bit, 32-bit, 64-bit, 128-bit etc.).

The feature of sonifying inherent browser functions is advantageous because it allows users 116 to receive browser information without interrupting their browser sessions. Because the inherent browser function information is conveyed via sound, this allows users to continue their visual browser sessions. Furthermore, this allows a user to receive possibly large amounts of information without requiring that the user read a display. This is beneficial because it provides for a more efficient and clear browser experience. More specifically, the sonification keeps consumers engaged and avoids the abandonment of e-commerce transaction, which frequently occurs when consumers do not feel their payment transactions are secure.

Application Program Example

In an exemplary embodiment of the present invention, resonant content experiences can be delivered to users via application programs. Application programs include standard applications that can run independently on a PC or other computer system. This includes such application programs as word processors and spreadsheet programs. As such, an application program can be content enriched by the application (software) vendor to convey information regarding the status of certain application program functions being currently performed. For example, an audio file can be associated with the edit mode of a word processor. In this example, an audio file, appropriate to the function, is executed when the word processor switches to edit mode. The associated audio file can be the sound of a bell. Further, an audio file can be executed when the word processor switches out of edit mode. The associated audio file can be the sound of a different bell. In general, any function of the word processor can be sonified to convey information about that function.

The feature of sonifying application program functions is advantageous because it allows users to receive application program information without interrupting their interactions with the application program. Because the application program function information is conveyed via sound, this allows users to continue their interactions with the application program. Furthermore, this allows a user to receive possibly large amounts of information without requiring that the user read a display. This is beneficial because it provides for a more efficient and clear application program experience.

Example Implementations

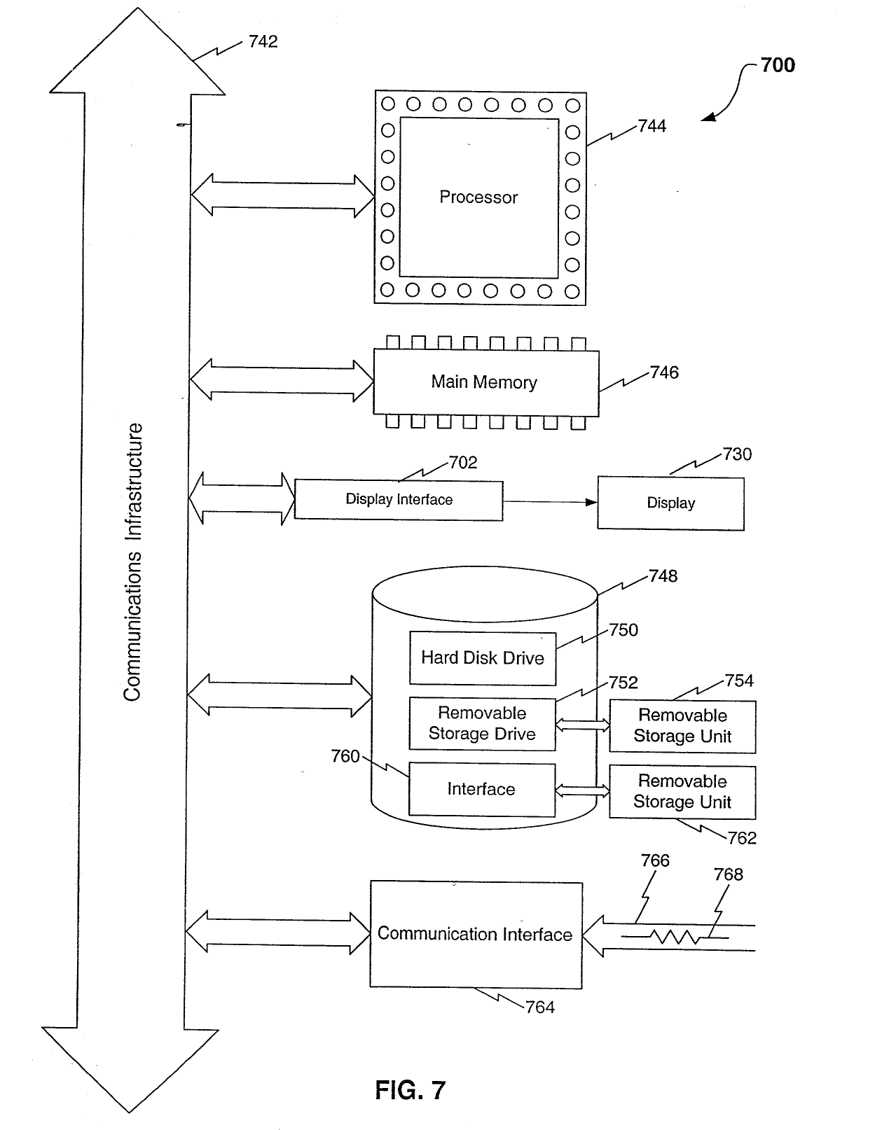

The present invention (i.e., content experience management system 100, flow 300, flow 400, or any part thereof) may be implemented using hardware, software or a combination thereof and may be implemented in one or more computer systems or other processing systems. In fact, an example of a computer system 700 is shown in FIG. 7. The computer system 700 represents any single or multi-processor computer. In conjunction, single-threaded and multi-threaded applications can be used. Unified or distributed memory systems can be used. Computer system 700, or portions thereof, may be used to implement the present invention. For example, the CEM system 100 of the present invention may comprise software running on a computer system such as computer system 700.

In one example, the CEM system 100 of the present invention is implemented in a multi-platform (platform independent) programming language such as JAVATM, programming language/structured query language (PL/SQL), hyper-text mark-up language (HTML), practical extraction report language (PERL), Flash programming language, common gateway interface/structured query language (CGI/SQL) or the like. Java™ enabled and JavaScript™ enabled browsers are used, such as, Netscape™, HotJava™, and Microsoft™ Explorer™ browsers. Active content Web pages can be used. Such active content Web pages can include Java™ applets or ActiveX™ controls, or any other active content technology developed now or in the future. The present invention, however, is not intended to be limited to Java™, JavaScript™, or their enabled browsers, and can be implemented in any programming language and browser, developed now or in the future, as would be apparent to a person skilled in the relevant art(s) given this description.

In another example, the CEM system 100 of the present invention, may be implemented using a high-level programming language (e.g., C++) and applications written for the Microsoft Windows™ NT or SUN™ OS environments. It will be apparent to persons skilled in the relevant art(s) how to implement the invention in alternative embodiments from the teachings herein.

Computer system 700 includes one or more processors, such as processor 744. One or more processors 744 can execute software implementing the routines described above, such as shown in FIGS. 2, 3A, and 4. Each processor 744 is connected to a communication infrastructure 742 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 700 can include a display interface 702 that forwards graphics, text, and other data from the communication infrastructure 742 (or from a frame buffer not shown) for display on the display unit 730.

Computer system 700 also includes a main memory 746, preferably random access memory (RAM), and can also include a secondary memory 748. The secondary memory 748 can include, for example, a hard disk drive 750 and/or a removable storage drive 752, representing a floppy disk drive, a magnetic tape drive, an optical disk drive, etc. The removable storage drive 752 reads from and/or writes to a removable storage unit 754 in a well-known manner. Removable storage unit 754 represents a floppy disk, magnetic tape, optical disk, etc., which is read by and written to by removable storage drive 752. As will be appreciated, the removable storage unit 754 includes a computer usable storage medium having stored therein computer software and/or data.

In alternative embodiments, secondary memory 748 may include other similar means for allowing computer programs or other instructions to be loaded into computer system 700. Such means can include, for example, a removable storage unit 762 and an interface 760. Examples can include a program cartridge and cartridge interface (such as that found in video game console devices), a removable memory chip (such as an EPROM, or PROM) and associated socket, and other removable storage units 762 and interfaces 760 which allow software and data to be transferred from the removable storage unit 762 to computer system 700.

Computer system 700 can also include a communications interface 764. Communications interface 764 allows software and data to be transferred between computer system 700 and external devices via communications path 766. Examples of communications interface 764 can include a modem, a network interface (such as Ethernet card), a communications port, interfaces described above, etc. Software and data transferred via communications interface 764 are in the form of signals which can be electronic, electromagnetic, optical or other signals capable of being received by communications interface 764, via communications path 766. Note that communications interface 764 provides a means by which computer system 700 can interface to a network such as the Internet.

The present invention can be implemented using software running (that is, executing) in an environment similar to that described above with respect to FIGS. 2, 3A, and 4. In this document, the term “computer program product” is used to generally refer to removable storage unit 754, a hard disk installed in hard disk drive 750, or a carrier wave carrying software over a communication path 766 (wireless link or cable) to communication interface 764. A computer useable medium can include magnetic media, optical media, or other recordable media, or media that transmits a carrier wave or other signal. These computer program products are means for providing software to computer system 700.

Computer programs (also called computer control logic) are stored in main memory 746 and/or secondary memory 748. Computer programs can also be received via communications interface 764. Such computer programs, when executed, enable the computer system 700 to perform the features of the present invention as discussed herein. In particular, the computer programs, when executed, enable the processor 744 to perform features of the present invention. Accordingly, such computer programs represent controllers of the computer system 700.

The present invention can be implemented as control logic in software, firmware, hardware or any combination thereof. In an embodiment where the invention is implemented using software, the software may be stored in a computer program product and loaded into computer system 700 using removable storage drive 752, hard disk drive 750, or interface 760.

Alternatively, the computer program product may be downloaded to computer system 700 over communications path 766. The control logic (software), when executed by the one or more processors 744, causes the processor(s) 744 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

As will be appreciated, according to the embodiments discussed above, two devices that are coupled can engage in direct communications, in indirect communications or a combination thereof. Embodiments of the present invention relate to data communications via one or more networks. The data communications can be carried by one or more communications channels of the one or more networks. Examples of a network include a Wide Area Network (WAN), a Local Area Network (LAN), the Internet, a wireless network, a wired network, a connection-oriented network, a packet network, an Internet Protocol (IP) network, or a combination thereof. A network can include wired communication links (e.g., coaxial cable, copper wires, optical fibers, and so on), wireless communication links (e.g., satellite communication links, terrestrial wireless communication links, wireless LANs, and so on), or a combination thereof.

In accordance with an embodiment of the present invention, instructions adapted to be executed by a processor to perform a method are stored on a computer-readable medium. The computer-readable medium can be a device that stores digital information. For example, a computer-readable medium includes a hard disk, a floppy disk, a tape and a compact disc read-only memory (CD-ROM), all as known in the art for storing software. The computer-readable medium is accessed by a processor suitable for executing instructions adapted to be executed. The term “adapted to be executed” is meant to encompass any instructions that are ready to be executed in their present form (e.g., machine code) by a processor, or require further manipulation (e.g., compilation, decryption, or provided with an access code, etc.) to be ready to be executed by a processor.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention. The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A method for providing content experience management to a client conducting business with a consumer via a touchpoint, comprising the steps of:
receiving information indicative of preferences of the consumer related to at least one of said client's products or services;
accessing a client profile database and applying a first set of rules to select a first subset of content files from a content database;
accessing a user profile data base and applying a second set of rules, using said received information, to select a second subset of content files from said content database;
accessing a content rules database and applying a third set of rules to select a third subset of content files from said content database;
applying a heuristic to select one of said third subset of content files from said content database; and
providing said one of said third subset of content files from said content database to at least one of the consumer and the client.

2. The method of claim 1, further comprising the step of:
applying the selected content file to the touchpoint.

3. The method of claim 2, further comprising the steps of:
monitoring the consumer's actions at the touchpoint; and
automatically providing additional content files to the touchpoint based on the consumer's actions.

4. The method of claim 2, further comprising the steps of:
monitoring the consumer's interaction with the touchpoint; and
adjusting at least one of said first, second and third rules based on the consumer's monitored interaction with the touchpoint.

5. The method of claim 4, comprising the step of:
providing additional content files to the touchpoint based in part on the consumer's action at the touchpoint.

6. The method of claim 2, wherein the content files located in said content database are audio files.

7. The method of claim 1, wherein the selected content file comprises a continual audio file that is applied to a client's Web site accessed by the consumer, wherein the continual audio file is executed at the Web site in a manner related to the consumer's actions at the Web site.

8. The method of claim 2, wherein said touchpoint comprises one of a group consisting of: a palmtop; a set-top box; a gaming console; a personal data assistant device; a mobile phone; a kiosk; and a personal computer.

9. The method of claim 4, comprising the step of:
providing at least one audio content file to a Web page.

10. A method according to claim 1, comprising the steps of:
providing a client's Web site to the consumer, wherein the consumer can purchase a cleint's product or service on said Web site;
providing a field to the user, wherein said field is associated with an attribute of said product; and
providing content to the user in response to information entered by the user via said field, wherein said content is one element of a composition of a plurality of content.

11. The method of claim 10, further comprising the steps of:
performing said steps of providing a field to the user and providing a content to the user for each of a plurality of attributes of said product, wherein said provided content produces said composition of a plurality of content.

12. The method of claim 10, comprising the step of: providing the user with a field for completing said purchase of said product.

13. The method of claim 10, comprising the step of:
applying the selected content file to the touchpoint.

14. The method of claim 13, comprising the steps of:
monitoring the consumer's interaction with the touchpoint;
adjusting at least one of said first, second and third rules based on the consumer's monitored interaction with the touchpoint.

15. A client-server computer system for content management of at least one client touchpoint comprising:
a port of access by at least one client;
a port of access by at least one user;
a media communication protocol coupled to said client and said user;
a content server accessible by said at least one client via said media communication protocol for providing content information to said at least one user in response to a query from said at least one client;
a content files database coupled to said content server;
a user profile database;
a content rules database;
a client profile database;
a recommendation engine for selecting content information based on dated stored in said user profile, content rules and client profile databases.

16. The system according to claim 15 implemented in a multi-platform programming language selected from the group consisting of: JAVATM, programming language/structured query language (PL/SQL), hyper-text mark-up language (HTML), practical extraction report language (PERL), Flash programming language, common gateway interface/structured query language (CGI/SQL).

17. The system according to claim 15 wherein Java™ enabled and JavaScript™ enabled browsers are used.

18. The system according to claim 15 wherein active content Web pages are used.

19. The system according to claim 15 implemented at least in part in programming language C++.

20. A client-computer system according to claim 15, further comprising a context/touchpoint database and wherein said content server comprises a Web server application and further comprises an online library of audio files coupled to said content server.

21. A client-server computer system according to claim 20, further comprising a context/touchpoint database and a firewall between said content server and said at least one client.

22. A client-server computer system according to claim 15, further comprising a context/touchpoint database and wherein one or more of said databases are implemented using a relational database schema.

23. A client-server computer system according to claim 15, further comprising a context/touchpoint database and wherein one or more of said databases are implemented using an object database schema.

24. A client-server computer system according to claim 15, wherein the selected content information comprises a series of audio files that are provided to a client's Web site accessed by the user.

25. The method of claim 24, wherein said touchpoint comprises one of a group consisting of: a palmtop; a set-top box; a gaming console; a personal data assistant device; a mobile phone; a kiosk; and a personal computer.

26. A system for providing content management for a client's touchpoint comprising:
means for receiving information related to a consumer user from at least one client;
means for sorting the information from said client into a plurality of categories based on predetermined filters and flags for at least one of the group consisting of: a type of product; a brand, and a type of market;
means for prioritizing brands, products, services and market types based on stored objectives for said client;
means for determining rules based in part on the objectives of said client;
means for identifying a user that accesses the touchpoint;
means for selecting content based on the rules and objectives of said client;
means for implementing the selected content;
means for monitoring the affects of the selected content on the user;
means for modifying at least one of said rules, content, client objectives, intent, and touchpoints based on feedback obtained from monitoring the user.

27. A system according to claim 26, wherein the means for selecting content comprises a Web server application and further comprises an online library of audio files coupled to said content server.

28. A system according to claim 27, further comprising a firewall between said means for selecting content and said client.

29. A system according to claim 26, further comprising data schema in the form of a relational database.

30. A system according to claim 26, further comprising data schema in the form of an object database.

31. A system according to claim 26, comprising means for distributing audio content files to the client's Web site in response to a user's actions at the Web site.

32. A system according to claim 27, wherein said touchpoint comprises one of a group consisting of: a palmtop; a set-top box; a gaming console; a personal data assistant device; a mobile phone; a kiosk; and a personal computer.

33. A computer-readable medium storing a plurality of instructions adapted to be executed by a processor for providing audio content to a client's touchpoint, the plurality of instructions comprising instructions to:
receive information from a touchpoint related to the consumer preferences of at least one consumer related to the client's products or services;
receive instructions from at least one client for content management of at least one touchpoint;
instruct a content server via a media communication protocol to retrieve audio content information with a recommendation engine using a system of rules stored in a dataschema; and
provide audio content files to the touchpoint in response to the client request via the media communication protocol.

34. A method of providing content management with a computer system comprising the steps of:
receiving information from a client that includes information about at least one of the brands and products of the client;
parsing the received information into categories based on stored filters and flags for the type of brands and products of the client;
prioritizing the brands and products based on predetermined weighted factors of the client or user;
determining at least one set of rules based on those factors;
identifying a user that accesses a client's touchpoint;
selecting content for application at the touchpoint based on the user's profile and the client's predetermined factors;
implementing the use of the selected content;
monitoring the affects of the use of the selected content; and
modifying one of rules, content, and client's factors based on the feedback obtained from monitoring the affects of implementing the content.

35. A method for providing content files to Web sites, the method comprising:
a step for a user to utilize a device to access a Web site of a client;
a step for the client accessing a content management system to select a content file in response to the user accessing the Web site;
a step for selecting a content file using a weighted recommendation subroutine;
a step for the client forwarding the selected content file to the user at the Web site;
a step for monitoring the user's reaction to the content file at the Web site;
a step for generating feedback data based on the client's reaction to the content file;
a step for sending the feedback data to the content management system; and
a step for refining the weighted recommendation subroutine for selecting content files with the feedback data.

36. The method of claim 35, comprising a step for dynamically updating rules stored in one or more data schemas based on the feedback data.

37. The method of claim 36, comprising a step for calling up at least one set of rules for allowing the weighted recommendation subroutine to select a content file from said one or more data schemas.

38. The method of claim 37, comprising a step for providing additional content information to the user in accordance with updated rules stored in said one or more data schemas.

39. The method of claim 35, wherein said user accesses the Web site with a device selected from the group consisting of: a palmtop; a set-top box; a gaming console; a personal data assistant device; a mobile phone; a kiosk; and a personal computer.

40. The method of claim 35, comprising the steps of:
monitoring a portion of the user's actions through a client's Web site; and
automatically providing additional content information to the Web site as the user executes predetermined actions at the Web site.

41. A method of selecting content data files for use on a Web site with a computer system comprising the steps of:
receiving a request for content data files for at least one of a client's Web sites;
providing information related to a user of the client's at least one Web site to a content application server program;
instructing a recommendation engine of the content application server program to apply a plurality of rules to a content database schema to select at least one content file from the database schema;
coupling said at least one selected content file to the client;
collecting feedback data related to the user's actions at the Web site after coupling said selected content file to the client;
coupling at lest a portion of the feedback data to the content application server program;
periodically updating the data base schema with updated content files.

42. A method according to claim 41, comprising the step of:
collecting data related to the user's Web site behavior.

43. A method according to claim 42, comprising the step of:
constructing client rules, user rules and content rules based on factors selected from the group consisting of demographics, psychographics and Web site behavior;
periodically updating the client rules, user rules and content rules based on collected data of Web site behavior.

44. The method of claim 41, comprising the step of selecting audio content files for the Web site of the client.

45. A method according to claim 41, wherein user information provided by the client to the client management system is selected from the group consisting of user login preferences, user preferences read from at least one browser cookie, a user profile, and group demographic information.

46. A method according to claim 41, comprising the step of the client submitting a user profile information request to one or more clients in order to facilitate the reception of content that meets the clients objectives.

47. A method for providing content information to a user at a client Web site touchpoint, comprising the steps of:
detecting a user at the Web site touchpoint;
monitoring with an application program predefined market events related to the Web site touch point;
executing at least one audio file at the Web site touchpoint upon the occurrence of a predefined market event monitored by the application program;
monitoring some portion of the user's actions at the Web site touchpoint.

48. A method according to claim 47, comprising the steps of:
monitoring the status of a stock market; and
providing audio files to the Web site related to the occurrence of monitored stock market events.

49. A method according to claim 46, comprising the steps of:
inputting user-specific market information at the Web site touchpoint via a user interface;
determining audio content for the Web site touchpoint based in part on the input user-specific information; and
providing audio content to the Web site touchpoint in response to the input user-specific market information.

50. The method according to claim 47, comprising the steps of:
recalling an information file for the user from a database in response to detecting the user at the Web site touchpoint; and
applying a first set of rules to the user's information file in order to generate preferences for the user related to the Web site touchpoint and select audio files related to the determined preferences of the user in accordance with a second set of rules.

51. A method according to claim 50, comprising the steps of:
inputting user-specific market information at the Web site touchpoint via a user interface;
determining audio content for the Web site touchpoint based in part on the input user-specific information.
